(19) United States
(12) Patent Application Publication
(10) Pub. No.: US 2004/0254319 A1
(43) Pub. Date: Dec. 16, 2004

(54) Flurofunctional statistical polymers with low glass transition temperature and method for obtaining the same

(76) Inventors: Bruno Michel Ameduri, Montpellier (FR); Mario Boucher, Quebec (CA); Bernard Leon Boutevin, Montpellier (FR)

Correspondence Address: BURNS DOANE SWECKER & MATHIS L L P, POST OFFICE BOX 1404, ALEXANDRIA, VA, 22313-1404, US

(21) Appl. No.: 10/480,819

(22) PCT Filed: Jul. 3, 2002
(86) PCT No.: PCT/CA02/01010

(30) Foreign Application Priority Data
Jul. 5, 2001 (CA) 2 352 417

(51) Int. Cl. C08F 12/20

(52) U.S. Cl. 526/249; 526/286; 526/255; 526/253

(57) ABSTRACT

The invention concerns fluorofunctional statistical polymers of formula (V1), wherein: X, Y and Z represent a hydrogen atom and exhibiting in particular low glass transition temperatures obtained in particular from a B monomer of formula (I): F2C═CF—RF—SO2F, wherein: RF represents one or several vinylidene fluoride units and/or a hexafluoropropene unit and/or a chlorotrifluoroerthylene unit. The crosslinkable fluorosulphonated elastomers thus obtained are advantageously usable for making membranes, polymeric electrolytes, ionomers, membranes for fuel cells in particular hydrogen or methanol fuel cells, for obtaining gaskets and O-rings, rubber hose, pipes, pump bodies, diaphragms, piston heads (used in aeronautics, oil, automotive, mining and nuclear industries) and for plastics processes (as processing aids).

### FIELD OF THE INVENTION

The present invention relates to fluorofanctional copolymers and processes of obtaining same. These copolymers which have excellent physical properties, such as low glass transition temperatures, are particularly adapted for use in numerous fields of industrial applications for example in so called high technology fields.

The present invention also concerns processes enabling to prepare these copolymers, as well as useful intermediates in providing processes permitting the synthesis.

The term copolymer as used within the scope of the present invention relates to compounds formed of macromolecules containing 2, 3, 4, 5, 6 or more different monomer units. Such high molecular weight compounds are obtained when one or more monomers are polymerized together. By way of examples of copolymers thus obtained from 3, 4, 5 or 6 different monomer units, terpolymers, tetrapolymers, pentapolymers and bexapolymers, respectively obtained by terpolymerization, tetrapolymerization, pentapolymerization and hexapolymerization, may be mentioned.

The term telomer as used within the framework of the present invention is used for example to qualify a compound of structure X(M₁)ₖY in which X and Y represent chain transfer agent groups; M₁ represent the monomer unit and k is a whole natural munber that generally varies from 1 to 100.

On the other hand, the terms telomer, telornerization and cotelomerization that appear in the present invention are explicitly defined in the publication of B. Ameduri and B. Boutevin, Telomerisation Reactions of Fluorinated Alkenes, R. D. Chambers, Editor <<Topics in Current Chemistry>>, Springer-Verlag, Heidelberg, volume 192, pages 165−233 (1997).

### PRIOR ART

Fluorinated elastomers show a unique combination of properties (thermic resistance, resistance against oxidation, ultraviolet rays (UV), ageing, corrosive chemical agents, fuiels and water absorption; low surface tensions, dielectric constants and refraction indices). The combination of these properties made it possible for them to find applications in so called high tech fields, by way of example: seals (spatial and aeronautic industry), semi-conductors (microlectronics), hoses, pipes, pump bodies and diaphragms (chemicaL automobile and petroleum industries).

Fluorinated elastomers (Polym. J. 17 (1985) 253 and Kaut. Gummi Kunst. 39 (1986) 196), and in particular copolymers based on vinylidene fluoride (or 1,1-difluoroethylene, VDF) are choice polymers for applications such as coatings and paints or more recently membranes or components of fuiel batteries, are resistant under tough, reducing or oxidizing conditions as well as against hydrocarbons, solvents, lubricating agents (Prog. Polym.

Sc. 26 (2001) 105).

However, in order to improve their properties of chemical inertia and their mechanical properties, it is necessary to cross-link these elastomers. VDF based elastomers may be cross-linked in different manners (chemical in the presence of polyamines, polyalcohols and organic peroxides or ionizing radiations or by electron bombardment), well described in Progr. Poly. Sc. 14 (1989) 251 and 26 (2001) 105, Rubber Chem. Technol. 55 (1982) 1004), in “Modem Fluoropolymers”, chapter 32, page 597 or in the article Angew. Makromol. Chem. 76/77 (1979) 39. Possibly, however, the products cross-linked with polyamines or polyalcohols do not correspond to desired optimal applications [elastomers as seals or holes, diaphragms, pump bodies for use in the automobile industry (Casaburo, Caoutchotics et Plastiques, 753 (1996) 69)]. However, cross-linking of sulfonyl groups (—SO₂F) is more promising. However, the fluorosulfonated polymers described in the literature are not numerous.

For example, DuPont sells Nafion® membranes by co-polymerization of tetrafluoroethylene (TFE) with the monomer F₂C═CFOCF₂CF(CF₃)OC₂F₄SO₂F. In the same manner Asahi Glass uses this sulfonated monomer for the manufacture of Flemion® membranes. Other monomers having the same function are also used, for example F₂C═CFOCF₂(CF₃)OC₃F₆SO₂F (for the Aciplex® membranes of Asahi Chemical) or CF₂═CFOC₂F₄SO₂F (U.S. Pat. No. 4,358,412) or with a carboxylate function such as the monomer F₂C═CFO[CF₂CF(CF₃)O]ₓ(CF₂)_{y}CO₂CH₃ (for the Nafion® or Aciplex® membranes when x is equal to 1 and y is equal to 2, and for the Flernion® membranes when x is 0 and y is 3). These membranes may for example be used as separator film in faiel batteries fed for example with hydrogen or methanol.

On the other hand the publication J. Fluorine Chem. 72 (1995) 203 as well as U.S. Pat. No. 5,463,005 (1995) mention the synthesis of original sulfonimide monomers F₂C═CFOCF₂CF(CF₃)OC₂F₄SO₂N(Na)SO₂R (where R represents the groups CF₃ or C₄FₛSO₂N(Na)SO₂CF₃) which have been copolymerized with TFE to give new membranes. Moreover, PCT Applications WO 99/45048 and WO 01/49757 A1 describe the easy copolymerization of VDF with perfluoro(4-methyl-3,6-dioxaoct-7-ene) sulfonyl filoride (PFSO₂F), or CF₂═CFOCF₂CF(CF₃)OC₂F₄SO₂F. On the other hand, U.S. Pat. No. 3,282,975 as well as PCT Application WO 01/49760 A1 describe the terpolymerization PFSO₂F/VDF/HFP. PCT Application WO 01/096268 A2 as well as Canadian Application 2,328,433 respectively concerning the preparation of brominated fluorosulfonated and fluorosulfonated nitrile elastomers, based on VDF/PFSO₂F and brominated or nitrile monomers should also be mentioned. On the other hand, the use of monomers containing sulfonyl fluoride ends promote cross-linking (for example with hexamethyldisilazane) of the polymers formed and improve their thermostability, their mechanical properties and their resistance to chemical agents, to petroleum, to strong acids and to oxidation,

It can be observed in the art that most of the copolymer synthesis based on fluorosulfonated monomers imply the use oftetrafluoroethylene (TFE).

In the field of fluorosulfonated monomer containing HFP synthesis, the art essentially describes trifluorovinyloxy monomers with sulfonyl fluoride ends (PFSO₂F monomers for the Nafion@ mernbraane, U.S. Pat. No. 3,282,875 (1966), for Flemiolie or the Aciplexscopolymer).

On the other band, the provision of the synthesis of monomers of structure: CF=CF(CF 2)_{X}OC₂F₄SO₂N(Na)SO₂CF₃, wherein x=0 or 1; F₂C═CFOCF₂CF(CF₃)OC₂F₄SO₂N(Na)R wherein R represents the groups: SO₂CF₃, SO₂(C₂F₄)NSO₂N(Na)SO₂CF₃ wherein n=2, 4 was obtained and is described in J. Fluorine Chem., 72 (1995) 203 and in U.S. Pat. No. 5,463,005.

Notwithstanding this, no fluorinated monomer with sulonyl fluoride end containing one or more VDF units and/or a CUTE and or HFP unit has been described in the art. However, except for the synthesis of the monomer F₂C═CFSO₂F (described in U.S. Pat. No. 3,041,317), no article or patent mentions the synthesis, and a fortiori the copolymrenzation of trifluoroviniyl monomer with slitfonyl fluoride end containing no ether bridge, with VDF, as well as the copolymerization of these two monomers with HFP, which constitutes the aim of this invention.

Consequently, there was a need for new copolymers having for example elastomeric properties and/or a good thermic stability resulting for example from low glass transition temperatures.

There was also a need for such monomers that can be easily synthesized and that could advantageously be used in new ways of synthesizing copolymers.

### SUMMARY OF THE INVENTTON

The present invention describes the preparation and copolymerization of highly fluorinated trifluorovinyl monomenrs with sulfonyl fluoride (MFSO₂F) ends and containing vinylidene fluoride (VDF), and/or hexafluoropropene (HFP), and/or chlorotrifluoethylene (CTFE) with fluorinated alkenes. This process leads to the synthesis of new copolymers, for example to new cross-linkable fluorosulfonated elastomeric copolymers having very low glass transition temperatures (Tg) A good resistance to acids, petroleum and to fuiels and good properties of handling. The above elastomers that contain no tetrafluoroethylene (TFE), nor siloxane group, consequently demonstrate an onrginal characteristic with respect to the copolymers of the prior art described with comparable properties.

The present invention also relates to new fluorinated monomers and the use of said fluorinated monomers in the synthesis of the copolymers of the invention, as well as to useful precursors (such as original telomers) for the synthesis of these fluorinated monomers.

### DETAILED DESCRIPTION OF THE INVENTION

A first object of the present invention consists of the family of fluorofunctional random copolymers corresponding to formula VI:

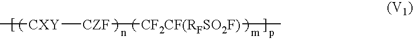

in which: X, Y and Z represent a hydrogen or fluorine atom or a CF₃ group

n, rm and p independently represent natural whole numbers that are preferably comprised between 1 and 20 for n, between 1 and 10 for m, and between 5 and 400 for p; and

R_{F} represents one or more units selected from the group consisting of vinylidene fluoride, hexafluoropropene and chlorotrifluoroethylene units.

A preferred sub-family consists of the flaorofunctional random copolymers corresponding to formula VI:

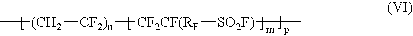

in which: n, rn and p are natural whole numbers that independently vary between 1 and 20 for Ti, (preferably n varies between 3 and 10), between 1 and 10 for m (preferably m varies between 1 and 5) and between 5 and 400 for p (preferably p v ari es from 10 to 300);

R_{F} represents one or more units selected from the group comprising vinylidene fluoride, hexafluoropropene and chlorotrifluoroethylene units.

Other preferred sub-families comprise the fluaorosulfonated copolymners of tie invention that contain from 68 to 96 mole % of vinylidene fluoride and/or from 4 to 32 mole % of highly fluorinated trifluorivinyl monomer with sulfoniyl fluoride end.

Still more preferably, among the fluorosulfonated copolymers of the invention, the highly fluorinated trifluiorovinyl monomer wvith sulfonyl fluoride enid is the 1,1,3,4,4-pentafluorobut-3-ene-1-sulfonyl fluoride or the 1, 1, 1)2,3,3,4,5,5-nonafluoropent-4-ene-2-sulfonyl fluoride.

A second object of the present invention consists in a process making it possible to prepare copolymners according to the present invention. This process comprises the reaction of a compound of formula I:

F₂C═CF—R_{F}—SO₂F (I)

in which: R_{F} represents one or more units selected from the group comprising vinylidene fluoride, hexafluoropropene and chlorotrifluoethylene units;

with a compound corresponding to formula V:

XYC═CZF (V).

Preferably, the process according to the invention is carried out by using as tarting products, compounds I of formula II:

F₂ C═CF(CH₂CF₂)_{w}[CF₂CF(CF₃)]ₓ(CF₂CFCl)_{y}SO₂F (II)

in which: w, x and y are natural whole numbers that independently vary between 0 and 10 (preferably lower or equal to S) for w, between 0 and 5 (preferably lower or equal to 1) for x and between 0 and 5 (preferably lower or equal to 1) for y.

An advantageous way of carrying out the invention, comprises the reaction of a compound corresponding to formula V′:

F₂C═CH₂ (V′)

with a compound of formula I as previously defined.

Another preferred sub-family of copolymers according to the invention consists of the sub-famnily of fluorofunctional random copolymers corresponding to formula VIII:

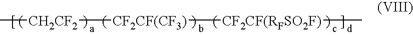

in which: a, b c and d independently represents natural whole numbers, such that the ratio a/b varies between 1 and 15 (preferably this ratio varies between 2 and 10), the ratio a/c varies between 1 and 25 (preferably this ratio varies from 2 to 15) and d varies from 10 to 400 (preferably d varies from 25 to 250);

R_{F} represents one or more units selected from the group comprising vinylidene fluoride, hexafluoropropene and chlorotrifluoroetlhylene units.

According to another preferred embodiment of the invention, the fluorosulfonated copolymers contain from 54 to 87 mole % of vinylidene fluoride and/or 11 to 34 more % of hexafltloropropene and/or from 2 to 12 mole % of highly fluorinated trifluorovinyl monomer with sulfonyl fluoride end.

Still more preferably, among these fltorosulfonated copolymers, the highly fluorinated trifluorovinyl monomer with sulfonyl end is 1,1,3,4,4-pentafluorobut-3-ene-1-sulfonyl fluoride,

By way of example, a fluorosulfonated copolymer according to the invention comprises the following chemical functions or fluorinated groups:

—SQ₂F;

—CF₂CF(CF₃)—;

tBuO-CF₂CH2—;

—CH₂CF₂—CH₂CF₂—CH2CF₂—;

—CF₂CF(R_{f})-CH₂CF₂—CH₂CF₂—;

—CF₂CF(R_{f})—CH₂CF₂—CH₂CF₂—CF₂CF(R_{F})—;

—CH₂CF₂—CH₂CF₂—CF₂CH2—;

—CF₂CF(CH₂CF₂SO₂F)-CH₂CF₂;

—CF₂CF(R_{F}SO₂F)-CH₂CF₂—CF₂CFRF)—;

—CH₂CF₂—CH2CF₂—CF₂CF(R)—;

—CH2CF₂SO₂F;

—CH₂CF₂—CH₂CF₂—CF₂CH₂—;

—CH₂CF₂—CF₂CH₂—CH₂CF₂—;

—CH₂CF₂—CF₂CF(CF₃)—CH₂CF;

—CF₂CF(R_{F}—SO₂F)-CFF₂CF(CF₃)—CH₂CF₂—;

—CH₂CF₂—CF₂CF(R_{F}SO₂F)-CH₂CF₂—;

—CH₂CF₂—CF₂CF(R_{F}SO₂F)-CF₂CH₂;

—CH₂CF₂—CF₂CF(CH₂CF₂SO₂F)-CH₂CF₂—; and

—CH₂CF₂—CF₂CF(CF₃)—,

respectively associated with the following chemical displacements, expressed in ppm, in RMN of the ¹⁹F:

+45;

−70 to −75;

−83;

−91;

−92;

−93;

−95;

−105;

−108;

−110;

−112;

−113;

−116;

−120;

−121;

−122;

−127;

−161 to −165; et

−180 to −185.

The fluorosulfonated copolymers in which the highly fluorinated trifluorovillyl monomer with sulfoniyl fluoride end is the 1,1,1,233,3,4,5,5-Donafluoropent-4ene-2-sulfonyl fluoride have a specific interest.

Another example of fluorosulfonated copolymer according to the invention has the following chemical functions or fluorinated groups:

—SO₂F;

—CF₂CF(CF₃)—;

—CF₂CF(CF₃)SO₂F;

tBuO-CF₂CH₂—;

—CH₂CF₂—CH₂CF₂—CH₂CF₂—;

—CH₂CF₂—CH₂CF₂—CF₂CH₂—;

—CF₂CF(R_{F}SO₂F)-CH₂CF₂—CF₂C_{F}(R_{F}SO₂F)—;

—CH₂CF₂—CF₂CFR_{F}SO₂F)—et —CH₂CF₂CF₂CF(CF₃)—;

—CH₂CF₂—CH₂CF₂—CF₂CF₂—;

—CH₂CF₂—CF₂CH₂—CH₂CF₂—;

—CH₂CF₂CF₂CF(CF₃)—;

—CH₂CF₂—CF₂CF(RFS O₂F)—CF₂CF(CF₃)—;

—CF₂CF[CF₂CF(CF₃)SO₂F]—CH₂CF₂—;

—CH₂CF₂—CF₂CF(R_{F}SO₂F)—CF₂CH₂—;

—CH₂CF₂—CF₂CF(CF₃)—;

—CH₂CF₂—CF₂CF(R_{F}SO₂F)—CH₂CF₂—; et —CF₂CF[CF₂CF(CF₃)SO₂F]—CH₂CF₂—,

respectively associated with the following chemical displacements, expressed in ppm, in PMN of ¹⁹F:

+45;

−70 to −75;

−75 to −77;

−83;

−91;

−95;

−108;

−110;

−113;

−116;

−120;

−122

−125

−127;

−180;

−182; and

−205.

A particularly interesting sub-family of copolymers according to the invention comprises the fluorosulfonated copolymers such as defined previously and those that can be obtained by one of the processes defined previously, said copolymers being characterized in that they are cross-linkable fluorosulfonated elastomers.

Another particularly interesting sub-family comprises the fluorosulfoliated copolymers previously defined and those that can be obtained by one of the processes previously defined and that have low glass transition temperatures (T_{g}). Preferably, these fluorosulfonated copolymers have a glass transition temperature, measured according to ASTM E-1356−98 norm, that is lower than 0° C. Still more preferably the fluorosulfonated copolymers according to the invention have a glass transition temperature between −30 and −5° C., terminals included. Still more preferably, these fluorosulfonated copolymers have a glass transition temperature lower than −20° C.

ADother particularly interesting sub-family comprises the fluorosulfonated copolymers such as previously defined or as obtained by one of the previously defined processes and that have a thermo-stability, measured by thermo-gravimetry (((TGA>)) up to 300° C. under air at 10C per minute, a temperature value at which a loss of weight of 5% is measured. Still more preferably, the sub-family comprises copolymers that have a thermo-stability up to 315° C. under air at 10° C. per minute, a temperature value at which a loss of weight of 5% is measured.

Another object of the present invention is constituted by a process for preparing copolymers according to the invention comprising the reaction:

of a compound corresponding to formula V′:

F₂C═CH₂ (V′)

with a compound of formula I:

F₂C═CF—R_{F}—SO₂F (I)

in which: R_{F} represents one or more units selected from the group consisting of vinylidene fluoride, hexafluoropropene and chlorotrifluoroethylene units; and

with a compound corresponding to formula VII:

F₂C═CFCF₃ (VII)

The processes according to the invention are preferably carried out in batch (in<<batch>>).

According to another advantageous embodiment, the processes according to the invention are carried out in emulsion, in micro-emulsion, in suspension or in solution.

On the other hand, the copolymerization is preferably carried out in the presence of an organic radical initiator or in the presence of at least one persulfate. The radical initiator is at least one peroxide and/or at least one perester.

By way of illustration, the copolymerization process according to the invention may be carried out in the presence of a t-butyl peroxypivalate at a temperature preferably between 70 and 80° C., still more preferably at a temperature of about 75° C. or in the presence of a t-butyl peroxide at a temperature preferably between 135 and 145° C., still more preferably at a temperature of about 1400 C.

The synthesis of the fluorofunctional copolymers of the present invention may also be advantageously carried olt in the presence of at least one organic solvent that is preferably selected from the group comprising:

esters of formula R-COO—R′ where R and R′ are hydrogen or alkyl groups that may contain 1 to 5 carbon atoms, but also hydroxy (OH) groups or ether groups OR″ where R″ is an alkyl containing from 1 to 5 carbon atoms, preferably R═H or CH₃ and R′ =CH₃, C₂H₅, i-C₃H₇, t-C₄H₉; and

fluorinated solvents of the type: perfluoro-n-liexane, n-C₄F₁₀, perfluoro-2-butyltetrahydrofurane (FC75); and

acetone, 1,2-dichloroethane, isopropanol, tertiobutanol, acetonitrile or butyronitrile; and

corresponding mixtures.

In a particularly interesting manner, the organic solvent comprises perfluoro-n-hexane or acetonitrile.

Advantageously, in the reaction mixture in which the copolymerization is carried out, the initial molar ratios [initiator]₀/Σ[monomers]o vary between 0.1 and 2%, preferably between 0.5 and 1%. In this formula, the expression [initiator]₀ means the initial molar concentration of initiator and the expression Σ[monomers]₀ means the initial total concentration of monomers.

Another object of the present invention is constituted by the family of monomers corresponding to formula I:

F₂C—CF—R_{F}—SO₂F (I)

in which: R_{F} represents one or more units selected from the group consisting of vinylidene fluoride, hexa-fluoropropene and chlorotrifluoroethylene units.

A preferred sub-family comprises the monomers corresponding to formula II:

F₂C═CF(CH₂CF₂)_{w}[CF₂CF(CF₃)]ₓ(CF₂CFCl)_{y}SO₂F (II)

in which: w, x and y are natural whole numbers that independently vary between 0 and 10 for w (preferably w varies between 0 and 5), between 0 and 5 for x (preferably x represents 0 or 1) and between 0 and 5 for y (preferably y represents 0 or 10).

Preferably, in these monomers, the vinylidene fluoride, hexafluoropropene and chlorotribluoroethylene units are randomly dispersed, i.e. they are not in the form of blocks.

Another preferred sub-family of monomers according to the invention comprises the compounds corresponding to formulae II₁and II₂:

F₂C═CFCH₂CF₂SO₂F (II₁)

F₂C═CFCF₂CF(CF₃)SO₂F (II₂)

The monomers according to the invention may advantageously be prepared par chemical transformation of the telomers of formula III:

ClCF₂CFCl(CH₂CF₂)_{w}[CF₂CF(CF₃)]ₓ(CF₂CFCl)_{y}I (III)

in which: w, x and y are natural whole numbers that independently vary between 0 and 10 (preferably lower than or equal to 5) for w, between 0 and 5 (preferably lower than or equal to 1) for x and between 0 and 5 (preferably lower than or equal to 1) for y.

said chemical transformation being a process including at least two or three of the following steps: sulfination, chlorination and fluorination of the-end group —SO₂Na;

into compounds of formula IV:

ClCF₂CFCl-R_{F}—SO₂F (IV)

in which: R_{F} represents the goup (CH₂CF₂)_{w}[CF₂CF(CF₃)]ₓ—(CF₂CFCl)y and where w, x and y are natural whole numbers that independently vary between 0 and 10 (preferably lower than or equal to 5) for w, between 0 and 5 (preferably lower than or equal to 1) for x and between 0 and 5 (preferably lower than or equal to 1) for y;

and by dechlorination of the fluorosulfonated telomers of formula IV thus obtained into a compound of formula II:

F₂C═CF(CH₂CF₂)_{w}[CF₂CF(CF₃)]ₓ(CF₂CFCl)_{y}SO₂F (II)

in which: w, x and y are natural whole numbers that independently vary between 0 and 10 (preferably lower than or equal to 5) for w, between 0 and 5 (preferably lower than or equal to 1) for x and between 0 and 5 (preferably lower than or equal to 1) for y.

Another object of the present invention comprises the use of the compounds of formula III:

ClCF₂CFCl(CH₂CF₂)_{w}[CF₂CF(CF₃)]ₓ(CF₂CFCl)_{y}I (III)

in which: w, x and y are natural whole numbers that independently vary between 0 and 10 (preferably lower than or equal to 5) for w, between 0 and 5 (preferably lower than or equal to 1) for x and between 0 and 5 (preferably lower than or equal to 1) for y;

as precUrsor compouinds for obtaining compounds corresponding to formula II:

F₂C═CF(CH₂CF₂)_{w}[CF₂CF(CF₃)]ₓ(CF₂CFCl)_{y}SO₂F (II)

in which: w, x and y are the same as in formula III.

Another object of the present invention is constituted by the family of telomers corresponding to formula III previously defined. By way of example, one of the preferred telomers corresponds to formula III₁:

ClCF₂CFClCH₂CF₂I (III₁), or

to formula III₂:

ClCF₂CFClCF₂CF(CF₃)I (III₂)

The telomers of formulae III, III₁ and III₂ may advantageously be synthetized by telomerization or by copolymerization stepwise, of vinylidene fluoride and/or hexafluoropropene and/or chlorotrifluoroethylene with ClCF₂CFClI.

Another object of the present invention is constituted by a process of cross-linking sulfonyl fluoride groups of a fluorosulfonated copolymer selected from the family of cross-linkable fluorosulfonated elastomers previously defined, said process comprising contacting said polymer with a cross-linling agent permitting a reaction between two sulfonyA groups derived from adjacent polymer chains, to form said cross-linking bonds, the polymer thus obtained being characterised in that at least one fraction of the cross-linking bonds carries an ionic charge.

Another object of the present invention is constituted by the use of the cross-linkable fluorosulfonated elastomers previously defined to manufacture membranes, polymer electrolytes, ionomers, membranes for fuel batteries such as those fed with hydrogen or methanol; to give seals and O rings, hoses, pipes, pump bodies, diaphragms, piston beads (finding applications in the aeronautic, petroleum, automobile mining, nuclear industries) and in plasturgy (products used to help carrying out the processes).

Another object of the present invention is constituted by a process for the manufacture of membranes of the ion, and preferably the cation exchange type, said process comprising various transformations of the copolymers according to the invention, which transformations are generally mastered by one skilled in the art, the latter being for example described in the international publication carrying number WO 99/38897, and more specifically in examples 1 to 11 of said publication.

Such membranes can be obtained by a process comprising the transformation of one or more of the elastomers object of the invention according to techniques known to the one involved in the technique under consideration.

Such polymer electrolytes can be obtained by transformation of one or more of the etastomers object of the invention according to the techniques known by one involved in the technique under consideration.

Such ionomers can be obtained by a process comprising the transformation of one or more elastomers object of the invention by a process according to the techniques knowvn to one involved in the technique under consideration.

Such seals (O rings) can be obtained by a process comprising the transformation of one or more of the elastomers object of the invention according to the techniques known to one involved in the technique under consideration.

The present invention therefore concerns tle synthesis of reactive trifluorivinyl monomers based on VDF, HFP or CTFE containing a sulfonyl fluoride end and the obtaining of fluorinated elastomers based on VDF, or still on VDF and HPP, and their cross-linking, as well as their fields of application. Cross-linking of these fluorosulfonated polymers is carried out, for example, in the presence of hexametbyldisilazane.

### DETAILED DESCRIPTION OF CERTAIN ASPECTS OF THE INVENTION

Synthesis of trifluorovinyl monomers with stlfonyl fluoride end based on VDF and/or UFP and/or CTFE.

One of the first object of this invention consists in the provision of new highly fluorinated trifluorovinyl monomers, that are reactive in copolymerization with fluorinated olefins and have a sulfonyl fluoride end. This object is achieved with compounds corresponding to formula I:

F₂C═CFR_{F}SO₂F (I)

in which; RF represents one or more units selected from the group consisting of vinylidene fluoride, hexafluoropropene and chlorotrifluoroethylene units.

More particularly, the present invention proposes compounds corresponding to formula II:

F₂C═CF(CH₂CF₂)_{w}[CF₂CF(CF₃)]ₓ(CF₂CFCl)_{y}SO₂F (II)

in which w, x and y are natural whole numbers that independently vary between 0 and 10 for w, between 0 and 5 for x and between 0 and 5 for

These trifluorovinyl momomers containing component units VDF, and/or HFP, and/or CTFE are prepared by dechlorination of the corresponding precursors, represented by formula IV:

ClCF₂CFCl—R_{F}—SO₂F (IV)

in which R_{F} represents the group (CH₂CF₂)_{w}[CF₂CF(CF₃)]ₓ(CF₂CFCl)_{y} and wherein w, x and y are natural whole numbers that independently vary between 0 and 10 (preferably lower than or equal to 5) for w, between 0 and 5 (preferably lower than or equal to 1) for x and between 0 and 5 (preferably lower than of equal to 1) for y.

These intermediate reactants are obtained by fluorination, in the presence of KF, of the compounds with corresponding sulfonyl chloride ends, represented by formula IV′:

ClCF₂CFCl—R_{F}—SO₂Cl (IV′)

in which: R_{F} has the same meaning as in formula IV.

These chlorofluorinated derivatives are prepared by chlorination of molecules with —SO₂Na end, represented by formula IV″:

ClCF₂CFCl_{FF}—R_{F}—SO₂Na (IV″)

in which: R_{F} has the same meaning as in formula IV.

These (per)halogenated sulfinates are synthesized from ω-iodinated telomers, corresponding to formula III′, in the presence of Na₂S₂O₄/NaHCO_{3:}

ClCF₂CFCl-R_{f}-I (III′)

in which: R_{F} represents the group (CH₂CF₂)_{w}[CF₂CF(CF₃)]ₓ(CF₂CFCl)_{y} and wherein w, x and y are natural whole numbers that independently vary between 0 and 10 (preferably lower than or equal to 5) for w, between 0 and 5 (preferably lower than or equal to 1) for x and between 0 and 5 (preferably lower than or equal to 1) for y.

These telomers, represented by formula III′, are obtained by telomerization or by stepwise co-telomerization of VDP, and/or HFP, and/or CTFE with ClCF₂CFClI, the latter being prepared by adding ICl on CTFE.

By way of illustration, the synthesis of these trifluorovinyl monomers containing one or more VDF units, and/or a HFP unit, and/or a CTFE unit may for example be illustrated and summarized par the following reaction mechanism:

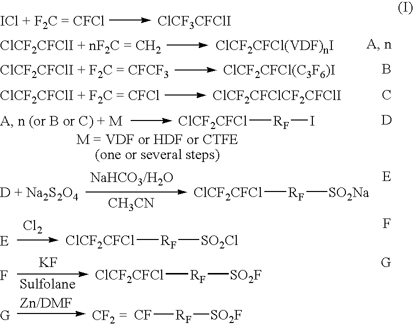

in which: n is a natural whole number between 0 and 5 inclusive;

R_{F} represents one or more vinylidene fluoride (VDF) units, and/or a hexafluoropropene (HFP) unit, and/or a chlorotrifluoroethylene (CTFE) unit.

Preparation of Fluorosulfonated Elastomers

The preparation of fluorosulfonated elastomers according to the invention, may be carried out by using different types of polymerization narnely emulsion polymerization, micro-emulsion polymerization, bulk polymerization, suspension polymerization and solution polymerization. Solution polymerization represents a preferred synthesis process.

The various fluorinated alkenes used have at most four carbon atoms and the structure R₁R₂═CR₃R₄ wherein the groups Rᵢ, i being a whole number from 1 to 4 inclusive, are such that at least one of the Rᵢ are fluorinated or perfluorinated. This therefore includes: vinyl fluoride (VF), vinylidene fluoride (VDF), trifluoroethylene, hexafluoropropene, cllorotrifluoroethylene (CTFE), 1-hydropentafluoropropyl ene, hexafluoroisobutylene, 3,3,3-trifluoropropene and generally all the fluorinated or perfluorinated vinyl compounds. On the other hand, perfluorovinyl ethers also act as comonomers. Among them, perfluoroalkyl vinyl ethers (PAVE) in which the ailcyl group has one to three carbon atoms, may be mentioned: for example, perfluoromethyl vinyl ether (PMVE), perfluoroethyl vinyl ether (PEVE) and perfluoropropyl vinyl ether (PPVE). These monomers may also include perfluoroalkoxy alkyl vinyl ethers (PAAVE), described in U.S. Pat. No. 3,291,843 and in Prog. Polyrn. Sci., (M. Yainabe et al. vol. 12 (1986) 229, A. L. Logothetis, vol. 14 (1989) 251, and B. Ameduri et al., vol.26 (2001) 105), such as perfluoro(2-n-propoxy)-propylvinyl ether, perfluoro-(2-methoxy)-propyl-vinyl ether; perfluoro (3-methoxy) propyl vinyl ether, perfluoro-(2-methoxy)-ethylvinylether; perfluoro-(3,6,9-trioxa-5,8-dimethyl)dodeca-1-ene, perfluoro-(5-methyl-3,6-dioxo)-1-nonene. Moreover, perfluoro-alkoxyalkyl vinyl ethers with carboxylic end or with sulfonyl fluoride end (such as perfluoro(4-methyl-3,6-dioxaoct-7-ene) sulfonyl fluoride) may also be used for the synthesis of fluorinated elastomers described in this invention. Mixtures of PAVE and PAAVE may be present in the copolymers.

The solvents used to carry out solution polymerization are preferably the following

esters of formula R-COO—R′ in which R and R′ are hydrogen or alkyl groups that may contain 1 to 5 carbon atoms, and also hydroxyl groups (OH) or ether groups OR″ where R″ is an alkyl that contains 1 to 5 carbon atoms. More particularly, R═H or CH₃ and R′ =CH₃, C₂H₅, i-C₃H₇, t-C₄H₉;

fluorinated solvents of the type: perfluoro-n-hexane, n-C4F₁₀, perfluoro-2-butyltetrahydrofarane (FC 75); and

acetone, 1,2-dichloroethane, isopropanol, tertiobutanol, acetonitrile or butyronitrile; and

corresponding mixtures.

The preferred solvents are acetonitrile and perfluoro-n-hexane in variable amounts. The amowuits of solvents used are generally about 40% to 75% of the volume of the reactor. On the other hand, when they are used as mixtures, these solvents are preferably in a proportion 50%-50%.

The reaction temperature range may be determined by the decomposition temperature of the initiator and varies from 20 to 200° C. The preferred temperatures used are between 55 and 80° C.

In the process according to the invention, the polymerization may be initiated in the presence of the usual radical polymerization initiators. Representative examples of such initiators include azoic (such as azobisisobutyronitrile, AIBN), dialkyl peroxydicarbonates, acetylcyclohexanesulfonyl peroxide, aryl or alkyl peroxide, such as dibenzoyl peroxide, dicumyl peroxide, t-butyl peroxide, t-alkyl perbenzoates and t-alkyl peroxypivalates, However, the preferred initiators are dialkyl peroxides (preferably t-butyl peroxide), dialkyl peroxydicarbonates, such as di-ethyl and di-isopropyl peroxydicarbonates, and t-allcyl peroxypivalates such as t-butyl and t-amyl peroxypivalates and, still more particularly, t-alkyl peroxypivalates.

For the emulsion polymerization process, we have used a wide range of cosolvents, iii various proportions in admixture with water. Similarly, various tensioactive agents have been used.

One of the polymerization processes used may also be by micro-emulsion as described in European Patent EP 250,767 or by dispersion, as indicated in U.S. Pat. No. 4,789,717 or European Patents 196,904; 280,312; and 360,292.

Reaction pressures vary between 2 and 120 bars depending on experimental conditions.

Chain transfer agents may also be generally used to regulate and mainly decrease the molecular weights of the copolymers. Among them, telogens containing 1 to 10 carbon atoms and having terminalbromine or iodine atoms such as, for exainple, the compounds of the type R_{F}X (where R_{F} is a perfluorinated group of formula CₙF₂ₙ₊₁, n=1 to 10 inclusive, X represents a bromine or iodine atom) or XR_{F}′X (with R_{F}′=(CF₂)ₐ where n=1 to 6 inclusive) or alcohols, ethers, or esters. A list of various transfer agents that caln be used in telomerization of fluorinated monomers is indicated in the publication <<Telomerinzation Reactions of Fluoroalkanes>>, B. Ameduri and B. Boutevin in the work <<Topics in Current Chemistry>> (Ed. R. D. Chambers), volume 192, pages 165−233, Springer Verlag (1997).

All the range of relative percentages of various copolymers that can be synthesized from the fluorinated monomers used, leading to the formation of the fluorinated copolymers was studied and the corresponding results are given in tables 1 and 2 hereinafter.

The products were analyzed in RNN of the ¹H and the ¹⁹F in acetone or deuterium DMF. This method of analysis has made it possible to verify without ambiguity the percentages of the comonomers introduced into the products. For example, from micro-structures characterized in the literature (Polymer 28 (1987) 224; J. Fluorine Chem. 78 (1996) 145) as well as in the international publications PCT WO 01/49757 A1 and WO 49760 A1, the relationship between the characteristic signals of the copolymers VDF/MFSO₂F (table 3) and of the copolymers HFP/MFSO₂F/VDF (tables 3 and 4) in RMN of ¹⁹F has made it possible to establish the structure of the products. This analysis shows the diades VDF/MFSO₂F, VDF/HFP and HFP/MFSO₂F as well as the head-tail and head-head sequences of the block units VDF (respectively at −91 and −113, −116 ppm).

The molar percentages of the different monomers introduced in the VDF/HFP/M₁FSO₂F copolymers were determined from equations 1, 2 and 3 indicated hereinafter and given in table 3, where M₁FSO₂F represents 1,1,3,4,4pentafluorobut-3-ene-1-sulfonyl fluoride, i.e. CF₂═CFCH₂CF₂SO₂F.

$$\begin{matrix}\% molaire de VDF = \frac{A}{A + B + C} & Equation 1 \\ \% molaire de HFP = \frac{B}{A + B + C} & Equation 2 \\ \% molaire de {M}_{1} {FSO}_{2} F = \frac{C}{A + B + C} & Equation 3\end{matrix}$$

in which:

A=L₈₃+L₉₁+L₉₂+L₉₃+L₉₅+L₁₀₈+L₁₁₀+L₁₁₃+L₁₁₆+L₁₂₇

B=L₁₂₀=L₁₂₁

C=L₁₀₅

Where L₁ is the value of the integration of the signal located at −i ppm on the spectrum RMN of ¹⁹F.

The molar percentages of the different monomers in the VDF/HFP/M₂FSO₂F copolymers were determined from equations 4, 5 and 6 indicated hereinafter and given in table 4, with M₂FSO₂F representing 1,1,1,2,3,3,4,5,5-nonafluoropent-4-ene-2-sulfonyl fluoride, or CF₂═CFCF₂CF(CF₃)SO₂F.

$$\begin{matrix}\% molaire de VDF = \frac{D}{D + E + F} & Equation 4 \\ \% molaire de HFP = \frac{E}{D + E + F} & Equation 5 \\ \% molaire de {M}_{2} {FSO}_{2} F = \frac{F}{D + E + F} & Equation 6\end{matrix}$$

in which:

D=L₈₃+L₉₁+L₉₅+L₁₀₂+L₁₀₈+L₁₁₀+L₁₁₃+L₁₁₆+L₁₂₇

E=L₁₂₀

F=L₁₂₂

where L₁ is the value of the integration of the signal located at −i ppm on the spectrum RMN of ¹⁹F.

By differential calorimetric analysis (DSC), it has been noted that the copolymers have a single glass transition temperature (T_{g}) and an absence of faision temperature (tables 1 and 2). These low values of T_{g} show an increased elastomeric character, that is particularly original for fluorosulfonated polymers. These glass transition temperatures (T_{g}) are measured according to ASTM norm E-1356−98.

In parallel fashion, the thermic stabilities, measured by thermogravimetric analysis (<(TGA))), carried out under air, of these fluorosulfonated copolymers are very satisfactory (tables 1 and 2).

The copolymers having, such compositions may find applications in components of fuel batteries fed with example with hydrogen or methanol, for example for the manufacture of a protonic membrane, as well as the preparation of O-rings, of pump bodies, of diaphragms having a very good resistance to fliels, gasoline, t-butyl methyl etber, alcohols, motor oils and strong acids (for example: HCl, HNO₃, and H₂SO₄), combined with good elastomeric properties, in particular a very good resistance at low temperatures. These copolymers also have the advantage of being cross-linkable in the presence of traditionally used agents.

Cross-linking of Fluorosulfonated Elastomers

The elastomers of this invention may be cross-linked by using, for example, systems based on hexamethyldisilazane. These systems are well known, such as those described in the article Inorg. Chem. 23 (1984) 3720, for the cross-linking of the sulfonyl functions, in International Patent WO 99/05126 and in Canadian Application 2,283,132.

On the other hand, il is well known that the perfitlorinated polymers cannot normally be cross-linked with traditionally used techniques for non fluorinated polymers because of the easy removal of the fluoride ion and of the steric hindrance of the perfluorinated chains.

However, the general technique described in PCT Application WO 99/38897, the content of which is incorporated herein by reference to the present description, makes it possible to produce cross-linkings, i.e. bonds, between the sulfonyl groups attached to the adjacent polymer chains, including those having a perfluorinated backbone, for example those derived from the following monomer and its copolymers:

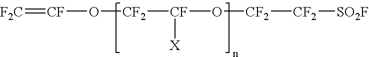

in which: X is F, Cl or CF₃;

n is 0 to 10 inclusive.

Advantageously, the cross-linking may be carried out while the polymer is in the form of a non-ionic polymer precursor, but after having been molded or pressed in desired shape. Therefore the result is a much higher mechanically resistant material. The present invention also concerns the molding or pressing of the cross-linked polymer in the form of membranes or hollow fibers (hereinafter “membranes”) for use in a fuel battery, an electrolyser in water, a chlorine-soda process, electrosynthesis, water treatment and the production of ozone. The use of the cross-linked polymers as catalysts for some chemical reactions, owing to the strong dissociation of the ionic groups introduced by the cross-linking technique and the insolubility of the polymer chain, is also part of the invention.

The introduction of stable cross-linkings is carried out by means of a reaction between two —SO₂L groups onrginating from adjacent polymer chains. The reaction is initiated by means of a cross-linkina agent, and permits the formation of derivatives according to the following formulae:

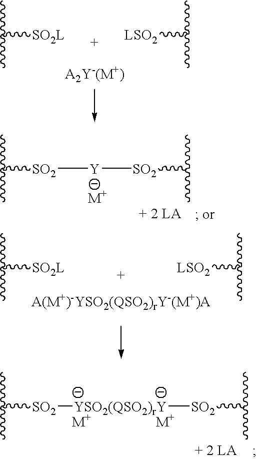

in which: r is 0 or 1;

M comprises an inorganic or organic cation;

Y comprises N or CR in which R comprises H, CN, F, SO₂R³, C₁₋₂₀ substituted or non substituted alkyl; C₁₋₂₀ substituted or non substituted alkylene, in which the substituent 10 comprises one or rnore halogen atoms, and in which the chain comprises one or more F, SO₂R, aza, oxa, thia or dioxathia;

R³ comprises F, C₁₋₂₀ substituted or non substituted alkyl; C₁₋₂₀ substituted or non substituted alkylede, in which the substituent comprises one or more halogen atoms;

Q comprises a divalent radical C₁₋₂₀ alkyl, C₁₋₂₀ oxaalkyl, C₁₋₂₀ azaalkyl, C₁₋₂₀ thiaalkyl, C₁₋₂₀ aryl or C₁₋₂₀ alkylaryl, in which each can optionally be substituted by one or more halogen atoms, and in which the chain comprises one or more oxa, aza or thia substituents;

A comprises M, Si(R′)₃, Ge(R′)₃ or Sn(R′)₃ in which R′ is C₁₋₁₈ alkyl;

L comprises a labile group such as a halogen atom (F, Cl, Br), an electrophilic heterocyclic compound N-imidazolyl, N-triazolyl, R²SO₃ in which R² is an optionally halogenated organic radical; and

R² comprises a proton; alkyl, alkenyl, oxaalkyl oxaalkenyl, azaalkyl, azaalkenyl, thiaalkyl, thiaalkenyl, dialkylazo, optionally hydrolysable silaalkyl, optionally hydrolysable silaalkenyl radicals, said radicals can be linear, branched or cyclic and comprising 1 to 18 carbon atoms; the cyclic or heterocyclic aliphatic radicals having 4 to 26 carbon atoms optionally comprising at least one lateral chain comprising one or more heteroatoms such as nitrogen, oxygen or sulfur, aryls, arylalkyls, alkylaryl and alkenylaryl radicals having 5 to 26 carbon atoms optionally including one or more heteroatoms in the aromatic nucleus or in a substituent.

The cross-linking reaction may imply the totality of the sulfonyl groups, or only a fraction thereof. The cross-linkirg reactants may be added or used according to different techniques well known to one skilled in the art. Advantageously, the polymer is molded under desired shape before cross-linking, for example in the form of membranes or hollow fibers, and the material is immersed or covered with a solution of the cross-linking agent in one or more solvents promoting the coupling reaction.

If only a fraction of the bonds bridging the polymer chains are required, the remaining —SO₂L groups may be hydrolyzed in a conventional manner in the form of sulfonate by alkaline hydrolysis.

The cross-linked polymer obtained according the process of the present invention may easily be separated from the secondary products of the reaction, that are for example volatile, such as (CH₃)₃SiF or (CH₃)₃SiCl. Alternately, the cross-linked polymer may be washed with an appropriated solvent such as water or an organic solvent in which it is insoluble. In addition, techniques well known to one skilled in the art, such as for example ion exchange or electrophoresis, may be used to change the cation M⁺obtained in the cross-linking reaction and/or obtained from the non cross-linking ionogen agent by the desired cation for the final application.

TABLE 1
Operating conditions and results of radical copolymerizations
utilising the monomer M₁FSO₂F

| | Wht | Weight | Weight | Weight | | VDF | M₁FSO₂F | HFP |
|---|---|---|---|---|---|---|---|---|
| | VDF | M₁FSO₂F | HFP | solvent | C₀ | initial | initial | initial |
| Ex. | (g) | (g) | (g) | (g) | (%) | (% mol) | (% mol) | (% mol) |
| 33* | 1.58 | 0.95 | 0 | 3.2 | 0.7 | 85. | 14.4 | 0 |
| | | | | (C₆F₁₄₎ | P.P. | | | |
| 34* | 13.3 | 12.8 | 0 | 55.0 | 1.0 | 78.7 | 21.3 | 0 |
| | | | | (CH₃CN) | P.P. | | | |
| 35* | 25.9 | 17.1 | 23.4 | 55.1 | 0.8 | 63.7 | 11.8 | 24.5 |
| | | | | (CH₃CN) | P.P. | | | |
| 36* | 26.2 | 19.5 | 18, | 55.0 | 0.8 | 65.9 | 14.2 | 19.9 |
| | | | | (CH₃CN) | P.P. | | | |

| | | | | | |
|---|---|---|---|---|---|
| VDF | M₁FSO₂F | HFP | Conversion rate | Yield by | T_{deg.} |

| | copo. | copo. | copo. | M₁FSO₂F | gas | Weight | T_{g} | 5% air |
|---|---|---|---|---|---|---|---|---|
| Ex. | (% mol) | (% mol) | (% mol) | (% mol) | (% mol) | (%) | (° C.) | (° C.) |
| 33* | 96.0 | 4.0 | 0 | n.c. | n.c. | n.c. | n.c. | n.c. |
| 34* | 84.2 | 15.8 | 0 | 41 | 53 | 38,. | −24.2 | 294 |
| 35* | 68.9 | 9.1 | 22.0 | 52 | 74 | 70.1 | −20.6 | 308 |
| 36* | 65.8 | 12.4 | 21.8 | 48 | 77 | 72.4 | −22.3 | 315 |

Temperature 75° C., duration 15 hours
P.P. = t-butyl peroxypivalate
n.c. = non calculated
*Tube of Carius in borosilicate
**Reactor of Hastelloy

TABLE 2
Operating conditions and results of radical copolymerizations
utilising the monomer M₂FSO₂F

| | | Weight | Weight | Weight | | VDF | M₁FSO₂F | HFP |
|---|---|---|---|---|---|---|---|---|
| | Wht VDF | M₂FSO₂F | HFP | solvent | C₀ | initial | initial | initial |
| Ex. | (g) | (g) | (g) | (g) | (%) | (% mol) | (% mol) | (% mol) |
| 37 | 15.2 | 8,. | 13.4 | 45.2 | 0.5 | 67.3 | 7.4 | 25.3 |
| | | | | | P.P. | | | |
| 38 | 16.9 | 9.9 | 12.9 | 50.3 | 0.5 | 68.0 | 8.5 | 23.5 |
| | | | | | t-Bu | | | |
| 39 | 28.5 | 11.3 | 13.5 | 50.2 | 0.6 | 71.3 | 10.3 | 18.4 |
| | | | | | t-Bu | | | |

| | | | | | |
|---|---|---|---|---|---|
| VDF | M₂FSO₂F | HFP | Conversion rate | Yield by | T_{deg.} |

| | copo. | copo. | copo. | M₂FSO₂F | gas | Weight | T_{g} | 5% air |
|---|---|---|---|---|---|---|---|---|
| Ex. | (% mol) | (% mol) | (% mol) | (% mol) | (% mol) | (%) | (° C.) | (° C.) |
| 37 | 73.5 | 4.8 | 21.7 | 61 | 49 | 55 | −20 | 301 |
| 38 | 76.9 | 7.0 | 16.1 | 65 | 62 | 59 | −26 | 282 |
| 39 | 80.6 | 8.6 | 10.8 | 70 | 67 | 65 | −29 | 275 |

Temperature 75° C. with t-butyl peroxypivalate and 140° C, with t-butyl peroxide, duration 6 hours
P.P. = t-butyl peroxypivalate
t-Bu = t-bulyl peroxide

TABLE 3
Characterization RMN of ¹⁹F of copolymers VDF/M₁FSO₂F/HFP

| | Chemical displace- |
|---|---|
| Structure | ment (ppm) |
| —SO₂F | +45 |
| —CF₂CF(CF₃)— | −70 to −75 |
| tBuO—CF₂CH₂— | −83 |
| —CH₂CF₂—CH₂CF₂—CH₂CF₂— | −91 |
| —CF₂CF(R_{F})—CH₂CF₂—CH₂CF₂— | −92 |
| —CF₂CF(R_{F})—CH₂CF₂—CH₂CF₂—CF₂(CF(R_{F})— | −93 |
| —CH₂CF₂—CH₂CF₂—CF₂CH₂— | −95 |
| —CF₂CF(CH₂CF₂SO₂F)—CH₂CF₂— | −105 |
| —CF₂CF(R_{F}SO₂F)—CH₂CF₂—CF₂CF(R_{F})— | −108 |
| —CH₂CF₂—CH₂CF₂—CF₂CF(R_{F})— | −110 |
| —CH₂CF₂SO₂F | −112 |
| —CH₂CF₂—CH₂CF₂—CF₂CH₂— | −113 |
| —CH₂CF₂—CF₂CH₂—CH₂CF₂— | −116 |
| —CH₂CF₂—CF₂CF(CF₃)—CH₂CF₂— | −120 |
| —CF₂CF(R_{F}—SO₂F)—CF₂CF(CF₃)—CH₂CF₂— | −121 |
| —CH₂CF₂—CF₂CF(R_{F}SO₂F)—CH₂CF₂— | −122 |
| —CH₂CF₂—CF₂CF(R_{F}SO₂F)—CH₂CF₂— | −127 |
| —CH₂CF₂—CF₂CF(CH₂CF₂SO₂F)—CH₂CF₂— | −161 to −165 |
| —CH₂CF₂—CF₂CF(CF₃)— | −180 to −185 |

TABLE 4
Characterization RMN of ¹⁹F of copolymers VDF/M₂FSO₂F/HFP

| | Chemical |
|---|---|
| | displacement |
| Structure | (ppm) |
| —SO₂F | +45 |
| —CF₂CF(CF₃)— | −70 to −75 |
| —CF₂CF(CF₂)SO₂F | −75 to −77 |
| tBuO—CF₂CH₂— | −83 |
| —CH₂CF₂—CH₂CF₂—CH₂CF₂— | −91 |
| —CH₂CF₂—CH₂CF₂—CF₂CH₂— | −95 |
| —CF₂CF(R_{F}SO₂F)—CH₂CF₂—CF₂CF(R_{F}SO₂F)— | −108 |
| —CH₂CF₂—CF₂CF(R_{F}SO₂F)—et | |
| —CH₂CF₂CF₂CF(CF₃)— | −110 |
| —CH₂CF₂—CH₂CF₂—CF₂CH₂— | −113 |
| —CH₂CF₂—CF₂CH₂—CH₂CF₂— | −116 |
| —CH₂CF₂CF₂CF(CF₃)— | −120 |
| —CH₂CF₂—CF₂CF(R_{F}SO₂F)—CF₂CF(CF₃)— | −122 |
| —CF₂CF[CF₂CF(CF₃)SO₂F]—CH₂CF₂— | −125 |
| —CH₂CF₂—CF₂CF(R_{F}SO₂F)—CF₂CH₂— | −127 |
| —CH₂CF₂—CF₂CF(CF₃)— | −180 |
| —CH₂CF₂—CF₂CF(R_{F}SO₂F)—CH₂CF₂— | −182 |
| —CF₂CF[CF₂CF(CF₃)SO₂F]—CH₂CF₂— | −205 |

### EXAMPLES

The following examples presented herein by way of illustration should in no way be interpreted as constituting some limitation to the present invention.

### Example 1

Synthesis of 1,2-Dichloro-1-Iodotrifluoroethane

In a Carius tube (inner diameter: 78 mm, thickness: 2.5 mm and length 310 mm) containing a magnetic stirring bar, 175.5 g (1.08 moles) of iodine monochloride ((ICl)), 1.1 g (0.006 mole) of benzophenone and 150 g of methyl chloride are cooled in a liquid nitrogen/acetone mixture (−80° C.). After three vacuum cycles/nitrogen, 131 g (112 moles) of chlorotrifluoroethylene (CTFE) are introduced therein. The tube is sealed and progressively heated to room temperature. Then, the solution is stirred wider UV (mercury vapor lamp—Philips HPK 125 W) during 6 hours. The raw reaction mixture is a dark pink liquid containing iodine crystals. A distillation gives 204.9 g of a pink liquid (T_{Eb}=99−101° C.) with a yield of 68%. The product obtained is a mixture of two isomers 1-iodo-1,2-dichlorotrifluoroethane (92%) and 1,1-dichloro-2-iodotrifluoroethane (8%).

RMN of ¹⁹F of the first isomer (CDCl₃) δ: system ABX

δ (F₂ₙ)=−62.31; δ(F_{2b})=−65.5; δ(F₁)=−72.87; J(F₂ₐ−F_{2b})=163.9 Hz;

J(F₂ₐ−F₁)=14.4Hz; J(F₂ₐ−F₁)=15.6 Hz.

RMN of ¹⁹F of the second isomer (CDCl₃). δ: system A₂X

δ(F₁)=−55.60; δ(F₂)=−67.65; J(F₁−F₂)=14.4 Hz.

### Example 2

Telomerization of Vinylideme Fluoride with 1,2-Dichloro-1-Iodotrifluoroethane

In a 300 ml Hastelloy reactor equipped with a imonometer, two valves (inlet valve and salting out), and a rupture disc, there are introduced 123.1 g (0.44 moles) of ClCF₂CFClI The reactor is closed, saturated with nitrogen under pressure to check its imperviousness, degassed, cooled to −80° C. in a mixture of acetone/liquid nitrogen and put under vacuum. There is introduced 45 g (0.44 mmole) of vinylidene fluoride (VDF). Then, the reactor is allowed to return to room temperature, then it is progressively heated up to 175° C. to give a pressure maximum of 35 bars. This pressure progressively decreases to 10 bars, which corresponds to a consumption of VDF. Tie time of reaction is 14 hours. After cooling to room temperature, the reactor is cooled down in ice and progressively degassed. A CPV chromatogram of the crude (pink liquid containing particles of iodine) shows a near total conversion of 1,2-chloro-1-iodoirifluoroethane, the major formation of the monoadduct ClCF₂CFClCH₂CF₂I (87%), of the diadduct ClCF₂CFCl(VDF)₂I (10%) and of the triadduct ClCF₂CFCl(VDF)₃I (3%). The global yield is 85%. After distillation, the monoadduct is first recovered, i.e. 1,2-dichloro-4-iodo-1,1,2,4,4-pentafluorobutane (ICF₂CH₂CFClCF₂Cl), pink liquid (T_{Eb}=133−135° C.), then the diadduct containing 91% of ClCF₂CFClCH₂CF₂CF₂CF₂I and ClCF₂CF ClCH₂CF₂CF₂CH₂I, pink liquid (T_{Eb}=78−84° C./20mm 14g).

RMN Characterization of the Monoaddtict

RMN of ¹H (CDCl₃)δ: =3.3 (m, CH_{2,} ³J_{HF} =16.0 Hz, 2H).

RMN of ¹⁹F(CDCl₃)δ=−38(m, CF₂I, 2F); −68 (system AB,

²J_{FF}=169.3 Hz, ³J_{F1F2}=9.5 Hz, ³J_{F1bF2}=9.8 Hz, ClCF₂, 2F); −118.5

and −122.3 (part X of a system ABX, ³J_{FH}=9.6 Hz, CFCl—, 1F).

RMN Characterization of the Diadduct

The diadduct is made of 91.% of the isomer

ClCF₂CFClCH₂CF₂CH₂CF₂I (A) and 9% of ClCF₂CFClCH₂CF₂CF₂CH₂I (B).

RMN ¹H (CDCl₃): δ =2.9 (m, CFClCH₂CF₂ of A) ; 3.2 (m, CFClCH₂ of B); 3.4 (qi, ³J_{HF}=16.0 Hz, CH₂CF₂I of A); 3.6 (tt, ³J_{HF}=18.0 Hz and ⁴J_{HF}=1.2 Hz, CF₂CH₂I of B).

RMN of ¹⁹F (CDCl₃)δ:=−38 (m, CH2CF₂I of A); −68 (system AB, ClCF₂ of A and B); −88.7 (m, CF₂CH₂CF₂of A)−108 (m, CF₂CH₂I of B); −112.8 (m, CF₂CF₂CH₂I of B); −118.2 and −122.6 (part X of system ABX, CFCl of A and B).

### Example 3

Telomerization of Hexatluoropropene with 1,2-Dichloro-1-Iodotrifluoroethane

In the same 300 ml reactor used as in example 2, there are introduced 70.4 g (0.25 mole) of ClCF₂CFClI and after closing the autoclave, cooling, vacuum nitrogen, vacuum, 90 g (0.63 mole of hexafluoropropene (HFP) are introduced therein. The reactor is heated up to 220° C. during 2.5 days and the pressure goes through a maximum of 92 bars, then it progressively decreases to 37 bars. After cooling the reactor and decassing the excess HFP, the autoclave is opened. This reaction crude (dark liquid containing crystals of iodine) made of the HFP (15%), traces of ClCF₂CFClI, of the monoadduct (78%) and the diadduct (6%), is distilled The monoadduct, i.e. 1,2-dichloro-4-iodo-perfluoropentane, is a pink liquid darkening under light (T_{Eb}=89−95° C./25 mm Hog) that contains two diastereoisomers.

RMN of ¹⁹F (CDCl₃)δ: −69 (m, ClCF₂, 2F); −74 (m, CF₃, 3F); −107

and −115 (m, CF₂CFI, two atoms of F non equivalent, 2F); −118

and −123 (m, CFCl, 1F)−145 (m, CFl, F)

Traces of the (<inverse>>insomer are noted, i.e. 1-iodo-3,4-dichloro-2-trifluoromethylperfluorobutane (ClCF₂CFClCF(CF₃)CF₂I).

RMN of ¹⁹F (CDCl₃)δ: −60 (m, CF₂I,2F); −69 (m, ClCF₂, 2F); −71 (m, CF₃, 3F); −125 and −132 (m, CFCl, 1F); −180 (m, CF, 1F).

### Example 4

Telornerization of chlorotrifluoroethylene (CTFE) with 1,2-dichloro-1-iodotrifluoroethane

Using the same reactor as the one described in example 2, there are introduced 82.5 g (0.294 mote) of 1,2-dichloro-1-iodotrifluoroethane and after cooling and vacuum, 35 g (0.300 mole) of chlorotrifluoroethylene (CTFE) are introduced therein. The reaction is carried out at 170° C. during 16 hours and the maximum pressure reaches 53 bars then it progressively decreases to 24 bars. The yield is 78%. The monoadduct, i.e. 1,2,4-trichloro-4-iodoperfluorobutane (95%), is distilled (T_{Eb}=115−1190 C/24 mm Hg) and contains two diastereoisomers.

RMN of 19F (CDCl₃)δ: −67 (m, ClCF₂, 2F); −69 to −72 (part X of a system ABX, m, CFClI, 1F); −98 to −105 (system AA′, CF₂CFCl, 2F); −120 to −126 (n, ClCF₂CFCl, 1F).

The minority isomer, 1,2,3-trichloro-4-iodoperfluorobutane (5%), also contains two diastereoisomers.

RMN of ¹⁹F (CDCl₃)δ: −49 to −53 (system AB, CF₂I, 2F)

−67 (m, ClCF₂, 2F); −115 (part X, CFClCF₂, 1F);

−118 to −123 (m, ClCF₂CFCl, 1F).

### Example 5

Telomerization of Hexafluoropropene with 4-Iodo-1,2-Dichloro-1,1,2,4,4-Pentafluorobutane

The same 300 ml reactor described in example 2 containing 62.5 g (0.182 mole) of 4-iodo-1,2-dichloro-1,1,2,4,4-pentafluorobutane and 82 g (0.547 mole) of HFP is heated under stirring at 210° C. durig 3 days. The pressure goes from 77 bars to 32 bars. The yield is 70%. The monoadduct, i.e. 6,7-dichloro-2-iodo-1,1,1,2,3,3,4,4,6,7,7-undecafluoro-heptane(ClCF₂CFClCH₂CF₂CF₂CFICF₃) is distilled (T_{Eb}=110−118° C./22 mm Hg) and contains tvo diastereoisomcrs.

RMN of ¹⁹F. (CDCl₃)δ: −68 (m, ClCF₂, 2F); −74 (m, CF₃, 3F)

−110(system AB, CH₂CF₂, 2F); −118 to −122 (m, CFCl, 1F);

−120 (system AB, CF₂CF, 2F); −145 (m, CF, 1F).

### Example 6

Telomerization of Hexafluoropropene with 1,2,4-Trichloro-4-Iodoperfluorobutane

The same reactor as the one used in example 2 containing 73.5 g (0.186 mole) of ClCF₂CFClCF₂CFClI and 78 g (0.52 mole) of HFP is heated at 230° C. during 3 days. The maximum pressure of 65 bars decreases to 24 bars. After reaction, the crude is distilled and after removal of the transfer agent that has not reacted, the monoadduct (T_{Eb}=48−51° C./0.1 mm Hg) is obtained with a yield of 76%. This monoadduct, i.e. 4,6,7-trichloro-2-iodoperfluoroheptane (ClCF₂CFClCF₂CFClCF₂CFICF₃), contains three diastereoisomers.

RMN of ¹⁹F (CDCl₃)δ: −68 (m, ClCF₂, 2F); −73 (m, CF₃, 3F); −99 to −100 (m, CF₂ central and CF₂CF, 4F); −114 to −119 (m, CFCl central, 1F); −121 and −125 (m, ClCF₂CFCl, 1F); −146 (m, CF, 1F).

### Example 7

Telomerization of Vinylidene fluoride with 1,2-Dichloro-4-Iodoperfluoropentane

The same 300 ml reactor containing 180.3 g (0.42 mole) of 1,2-dichloro-4-iodoperfluoropentane and 30 g (0.47 mole) of VDF is heated at 1800 C during 15 hours. The maximum pressure of 27 bars decreases towards 9 bars. After reaction, the crude is distilled with a yield of 75%. The product obtained (T_{Eb}=80−86° C./20 mm Hg), i.e. 1,2-dichloro-6-iodo-4-trifluoromethyl-1,1,2,3,3,4,6,6-octafluorohexane, contains two diastereoisomers.

RMN of ¹⁹F (CDCl₃)δ: −38 (m, CF₂I, 2F); −69 (m, ClCF₂, 2F)

−73 (m, CF₃, 3F); −110 and −118 (system AB, CF₂ central, 2F);

−121 and −126 (m, CFCl, 1F); −182 (m, CF, 1F).

### Example 8

Telomerization of Vinylidene Fluoride with 1,2,4-Trichloro-4-Iodoperfluorobtutane

The same 300 ml reactor containing 90.2 g (0.23 mole) of 1,2,4-trichloro-4-iodo-perfluorobutane and 28 g (0.43 mol) of VDF is heated at 180° C. during 16 hours, during which the pressure goes from 25 bars to 7 bars. After reaction, the monoadduct, i.e. 1,2,4-trichloro-6-iodo-1,1,2,3,3,4,6,6-octafluorohexane (ClCF₂CFClCF₂CFClCH₂CF₂I) is distilled (T_{Eb}=42−47° C./20imnm Hg) with a yield of 79%. Two diastereoisorners are present.

RMN of ¹H (CDCl₃) δ: 3.3 (m, CH₂, 2H).

RMN of ¹⁹F (CDC1)δ: −38 (m, CF₂1, 2F); −68 (m, ClCF₂, 2F)

−95 to −100 (m, CFClCF₂CFCl, 2F); −114 to −117 (m, CFClCH₂, 1F).

### Example 9

Synthesis of 1,2-Dichlorotrifluoroethane-1-Sulfonyl Chloride

A three neck flask equipped with a decanting funel, a cooler and a nitrogen inlet containing 100.1 g of Na2S2O4, 82.0 g of NaHCO3, 250 ml of water and 150 ml of acetonitrile is heated at 40° C. under stirring. At this temperature, 74.2 g (0.265 mole) of ClCF2CFClf are added thereto dropwise (the time of addition is about 45 minutes) tnder nitrogen and under strong stirring. The reaction mixture is stirred and heated at 40° C. during 15 hours. Acetonitrile is evaporated and the fluorinated phase is extracted with chloroform. The crude is washed three times with 120 ml of water saturated with NaCl. After drying and removal of chloroform, a brown wax is obtained. This perhalogenated sodium sulfinate is dissolved in 250 ml water and poured into a two neck flask equipped with a gas inlet and a trap filled with dry ice in which the upper end is connected to a container of a concentrated soda solution. Chlorine is bubbled in the reaction mixture during about 45 minutes and the solution is allowed to be stirred during an additional hour. The reaction crude is washed with an aqueous solution of NaICO₃ and is extracted with chloroform and dried on MgSO₄. After filtration and evaporation of chloroform, the perhalogenated sulfonyl chloride, i.e. 1,2-dichloro-1,2,2-trifluorethane-1-sulfonyl chloride is distilled (T_{Eb} 91−93° C./760 mm Hg).

RMofdu ¹⁹F (CDC)₃) δ: −70 (m, ClCF₂, 2F); −115 and −118 (m, CFCl, 1F).

### Example 10

Synthesis of 3,4-Dichloro-1,1,3,4,4-Pentafllorobutane1-Sulfonyl chloride

Under the same experimental conditions as in example 9, 91.0 g (0.265 mole) of ClCF₂CFClCH₂CF₂I are added dropwise at 40° C. in a three neck flask containing 100.1 g of Na₂S₂O₄, 82.0 g of NaHCO₃, 250 ml of water and 150 ml of acetonitrile. The same processes and treatments as in example 9 are used then chlorination is also carried out under the same conditions as those described in example 9. The sulfonyl chloride, i.e 3,4-dichloro-1,1,2,3,3-pentafluorobutane-1-sulfonyl chloride, is distilled (T_{Eb}=41−44° C. 22 mm Hg).

RMN of ¹H (CDCl₃) δ: 3,3 (system AB, CH₂, 2H).

RMN of ¹⁹F (CDCl₃) δ: −68 (m, ClCF₂, 2F); −96 (t, ³J_{HF}=16 Hz, CH₂CF₂, 2F); −118 to −122 (m, CFCl, 1F).

### Example 11

Synthesis of 4,5-Dichloro-1,1,1,2,3,3,4,5,5-Nonafluoro-Pentane-2-Sulfonyl Chloride

As previously, 90.2 g (0.210 mole) of C1CF₂CFClCF₂CFICF3 are added dropwise at 40° C. in a three neck flask containing 79.2 g of Na₂S₂O₄, 65.1 g of NaHCO₃, 200 ml of water and 120 ml of acetonitrile. After the same treatment, chlorination is carried out and gives a liquid (T_{Eb}=48−51° C./23 mm Hg) with a yield of 68%. The sulfonyl chloride, i.e. 4,5-dichloro-1,1,1,2,3,3,4,5,5-nonafluoropentane-2-sulfonyl chloride, has two diastereoisomers.

RMN of ¹⁹F (CDCl₃)δ: −68 (m, ClCF₂, 2F); −71 (m, CF₃, 3F); −110 to −114 (m, CF₂CF, 2F); −116 to −121 (m, CFCl, 1F); −195 (m, CF, 1F).

### Example 12

Synthesis of 1,3,4-Trichloro-1,2,2,3,4,4-Hexafluoro-Butane-1-Sulfonyl Chloride

As previously, 83.1 g (0.210 mole) of ClCF₂CFClCF₂CFClI are added dropwise at 40° C. in a three neck flask containing 80,2 g of Na₂S₂O₄, 65 g of NaHCO₃, 200 ml of water and 120 ml of acetonitrile. After reaction and same treatment, chlorination is carried and gives a liquid (T Eb=162−166° C./22 mm Hg) with a yield of 65% after distillation. The sulfonyl chloride, i.e. 1,3,4-trichloro-1,2,2,3,4,4-hexafluorobutane-1-sulfonyl chloride, has two diastereoisomers.

RMN of ¹⁹F (CDCl₃)δ: −68 (m, C1CF₂, 2F); −105 to −110 (m, CF central, 2F); −120 to −125 (m, CFCl, 1F); −132 (m, CFClSO₂C), 1F).

### Example 13

Synthesis of 6,7-Dichloro-1,1,1,2,3,3,4,4,6,7,7-Undecafluoro-Heptane2-Sulfonyl Chloride

As in the previous example, 47.1 g (0.095 mole) of ClCF₂CFClCH₂CF₂CF₂CFICF₃ are added dropwise at 40° C. in a tlree neck flask containing 36.2 g of Na₂S₂O₄, 30.1 g of NaHCO₃, 90 ml of water and 53 ml of acetonitrile. After reaction and treatrent, chlorination is carried out to give, after purification and distillation, a liquid CEhb 55−59° C. 0.1 mm Hg) vitli a yield of 69%. The suilfonyl chlonde, i.e. 6,7-dichloro-1,1,1,2,3,3,4,4,6,7,7-undecafluorobeptane-1-sulfonyl chloride has tvo diastereoisomers.

RMN of ¹H (CDCl₃) δ: 3,3 (m, CH₂).

RMN of ¹⁹F (CDCl₃)δ: −68 (m, ClCF₂, 2F); −71 (m, CF₃, 3F);

110 (m, CF₂CH₂, 2F); −118 and −122 (m, CFCl, 1F);

−120 (m, CF₂CF, 2F); −195 (m, CF, 1F).

### Example 14

Synthesis of 4,6,7-Trichloro-1,1,1,2,3,3 ,4,5,5,6,7,7-Dodecafluoro-Heptane-2-Sulfonyl Chloride

In the same experimental device as previously, 29.5 g (0.054 mote) of ClCF₂CFClCF₂CFClCF₂CFICF are added dropwise at 400 C in a three neck flask containing 20.3 g of Na₂S₂O₄, 16.2 g of NaHCO3, 50 ml of water and 30 ml of acetonitile. After reaction and purification, chlorination is realized and gives a liquid (T_{Eb}=69−740 C/0.1 mm Hg) with a yield of 66% after distillation. The suJfonyl chloride, i.e. 4,6,7-trichloro-1,1,1,2,3,3,4,5,5,6,7,7-dodecafluoroheptane-2-sulfonyl chloride has three diastereoisomers.

RMN of ¹⁹F (CDCl₃)δ: −68 (m, ClCF₂, 2F); −71 (m, CF₃, 3F);

−115 (m, CFCl central, 1F); −116 to −121 (m, ClCF₂CFCl, 1F);

−120 (m, CFClCf₂CFCl, 2F); −125 (m, CF₂CF, 2F); −195 (m, CF, 1F).

### Example 15

Synthesis of 5,6-Dichloro-3-Trifluloromethyl-1,1,3,4,4,5,6,6-Octafluoro-Hexane-1-Sulfonyl Chloride

As previously, 26.2 g (0.053 mole) of ClCF₂CFClCF₂CF(CF₃)CH₂CF₂I are added dropwise at 40° C. in a three neck flask containing 20.0 g of Na₂S₂O₄, 16.2 a of NaMCO₃, 50 ml of water and 30 ml of acetonitrile. After reaction, treatment and chlorination, the corresponding sulfonyl chloride (T_{Eb-42-45}° C./0.2 mm Hg) was obtained with a yield of 62% after distillation. The compound, i.e. 5,6-dichloro-3-trifluoromethyl-1,1,3,4,4,5,6,6-octafluorohexane-1-sulfonyl chloride has two diastereoisomers.

RMN of ¹H (CDCl₃) δ: 3,3 (m, CH₂).

RMN of ¹⁹F (CDCl₃) δ: −68 (m, ClCF₂, 2F); −71 (m, CF₃, 3F)

−112 (t, ³J_{HF}=16.2 Hz, CF₂SO₂C), 2F); −116 to −121 (m, CFCl, 1F);

−125 (m, CF₂ central, 2F); −182 (m, CF, 1F).

### Example 16

Synthesis of 3,5,6-Trichloro-1,1,3,4,4,5,6,6-Octaifluorohex3ne-1-Sulfonyl Chloride

Under the same conditions as those of the previous examples, 24.5 g (0.054 mole) of ClCF₂CFClCCF₂CFClCH₂CF₂I are added dropwise at 40° C. in a three neck flask containing 20.0 g of Na2S₂O₄, 16.1 g of NaHCO₃, 50 ml of water and 30 ml of acetonitrile. After reaction treatment and chlorination, the salfonyl chloride containing two CTFE units and a VDF unit is obtained (T_{Eb}=53−56° C./0.3 mm 1g) with a yield of 65% after distillation. The product, i.e. 3,5,6-trichloro-1,1,3,4,4,5,6,6-octafluorohexane-1-sulfonyl chloride has two diastereoisotners.

RMN of ¹H (CDCl₃) δ: 3,4 (m, CH₂).

RMN of ¹⁹F. (CDCl₃) δ: −68 (m, ClCF₂, 2F); −110 (m, CFClCH₂, 1F);

−112 (t, ³J_{HF}=15.9 Hz, CF₁SO₂Cl, 2F); −116 to −121 (m, ClCF₂CFCl, 1F);

−120 (m, CF₂ central, 2F).

### Example 17

Synthesis of 1,2-Dichlorotrifluoroethane-1-Sulfonyl Fluoride

71.2 g (0.285 mol) of ClCF₂CFClSO₂Cl are added dropwise in a three neck flask provided with a coolant (stumounted by a reserve of antifreeze) and an inlet of dry nitrogen, and containing 250 ml of cyclic sulfolane freshly distilled and dry and 100.2 g of activated potassium fluoride strongly stirred. The reaction mixture is heated at 80C during 12 hours under strong stirring and, after filtration and treatment, the crude is distilled. The sulfonyl fluoride, i.e. 1,2-dichlorotrifluoroethane-1-sulfonyl fluoride, is obtained (T_{Eb-85-87}° C./760 mm) with a yield of 83%.

RMN of ¹⁹F (CDCl₃)δ: +48 (s, SO₂F, 1F); −72 (system AB, ClCF₂, 2F); −115 (t, ³J_{FF}=15 Hz, CFCl, 1F).

### Example 18

Synthesis of 3,4-Dichloro-1,1,3,4,4-Pentafluorobutane-1-Sullfonyl Fluoride

Under the same conditions as in example 17, 15.0 g (0.048 mole) of ClCF₂CFClCH₂CF₂SO₂Cl are added dropwise in a three neck flask containing 42 in) of freshly distilled cyclic sulfolane, 16.7 g (0.287 mole) of activated potassium fluoride, heated at 80° C. during 12 hours. After filtration anid treatment, the corresponding sulfoniyl fluoride, i.e. 3,4-dichloro-1,1,3,4,4-pentafluorobutane-1-sulfonyl fluoride, is distilled (T_{Eb}=35−37° C./332 mm Hg) with a yield of 80%.

RMN of ¹H (CDCl₃) δ: 3.4 (m, CH₂).

RMN of ¹⁹F (CDCl₃)δ: +45 (s, SO₂F, 1F); −68 (m, ClCF₂, 2F);

−116 to −122 (m, CFCl, 1F); −117 (t, ³J_{HF}=16,2 Hz, CF₂SO₂F).

### Example 19

Synthesis of 4,5-Dichloro-1,1,1,2,3,3, 4,5,5-Nonafluoro-Pentane-2-Sulfonyl Fluoride

Using the same experimental protocol as the one described in example 17, 18.2 g (0.045 mole) of ClCF₂CFClCF₂CF(CF₃)SO₂Cl are added dropwise into a three neck flask containing 40 ml of freshly distilled cyclic sulfolane, 15.8 g (0.273 mole) of activated potassium fluoride, heated at 800 during 12 hours.

After filtration and treatment, the corresponding sulfonyl fluoride, i.e. 4,5-dichloro-1,1,1,2,3,3,4,5,5-nonafluoropentane-2-sulfonyl fluoride, is distilled (T_{Eb}=43−45C/25 mm Hg) with a yield of 82%.

RMN of ¹⁹F (CDCl₃)δ: +45(s, SO₂F, 1F); −68 (m, CF₂, 2F);

−71 (m, CF₃, 3F); −110 to−114 (m, CF₂CF, 2F),

−116 to −121 (m, CFCl, 1F); −197(m, CF, 1F).

### Example 20

Synthesis of 1,3,4-Trichloro-1,2,2,3,4,4-Hexafluoro-Butao e-1-Sulfonyl Fluoride

As previously, 17.8 g (0.048 mole) of ClCFCFClCF₂CFC1SO₂C1 are progressively added to a mnixture comprising 42.2 ml of freshly distilled cyclic sulfolane, 16.9 g (0.29 mole) of activated potassium fluoride, heated at 80° C. during 12 hours under strong stirring. After filtration and treatment, the corresponding sulfonyl fluoride, i.e. 1,3,4trichloro-1,2,2,3,4,4-hexafluorobutane-1-satfonyl fluoride, is distilled (T_{Eb}=61−63° C./23 mm Hg) with a yield of 85%.

RMN of ¹⁹F (CDCl₃) δ: +45 (s, SO₂F, 2F); −68 (m, ClCF_{2,} 2F);

−105 à−110 (m, CF₂ central, 2F);−120 à−125 (m, CFCl, 1F);

−135 (m, CFClSO₂F, 1F).

### Example 21

Synthesis of 6,7-Dichloro-1,1,1,2,3,3,4,4,6,7,7-Undecafluoroheptane-2-Sulfonyl Fluoride

Under the same conditions as previously, 16.2 g (0.034 mole) of ClCF₂CFClCH₂C₂F₄CF(CF₃)SO₂Cl are added dropwise in a three neck flask containing 30 ml of freshly distilled cyclic sulfolane, 12.1 g (0.209 mole) of activated potassium fluoride, heated at 80° C. during 12 hours. After filtration and treatment, the corresponding sulfonyl fluoride is distilled (T_{Eb} 53−55° C./20 nmmn Hg) with a yield of 83R The compound, i.e. 6,7-dichloro-1,1,1,2,3,3,4,4,6,7,7-undecafluoroheptane-2-sulfonyl fluoride, has two diastereoisomers.

RMN of ¹H (CDCl₃) δ: 3,1 (m, CHZ).

RMN of ¹⁹F (CDCl₃)δ: +45 (s, SO₂F, 1F); −68 (m, ClCF₂, 2F);

−71 (m, CF3, 3F); −110 (m, CF₂CH₂, 2F); −118 and −122 (m, CFC1, 1F);

−120 (m, CF₂CF, 2F); −197 (m, CF, 1F).

### Example 22

Synthesis of 4,6,7-Trichloro-1,1,1,2,3,3,4,5,5,6,7,7-Dodecafluoro-Heptane-2-Sulfonyl Fluoride

According to the same experimental device as in example 17, 13.7 g (0.026 mole) of ClCF₂CFClCF₂CFClCFICF(CF₃)SO₂Cl are slowly added, under strong stirring, to a mixture comprising 23 ml of freshly distilled cyclic sulfolane and 9.2 g (0.159 mole) of potassium fluoride heated at 80° C. during 12 hours. After filtration and treatmnent, the corresponding sulfonyl fluoride is distilled (T_{Eb}=110−114° C./19 mm Hg) with a yield of 70%. The product, i.e. 4,6,7-trichloro-1,1,1,2,3,3,4,5,5,6,7,7-dodecafluoroheptane-2- sulfonyl fluoride, has three diastereoisomers.

RMN of ¹⁹F (CDCl₃)δ: +45 (s, SO₂F, 1F);−68 (m, ClCF₂, 2F);

−71(m, CF₃, 3F); −115 (m, CFCl central, 1F);

−116 to −121 (m, ClCF₂CFCl, 1F); −120 (m, CFClCF₂CFCl, 2F),

−125 (m, CF₂CF, 2F); −197 (m, CF, 1F).

### Example 23

Synthesis of 5,6Dichloro-3-Trifluorometbiy-1,1,3,4,4,5,6,6-Octatluoro-Hexane-1-Sulfonyl Fluoride

Under the sarne conditions as previously, 15,5 g (0.033 mole) of ClCF₂CFClCF₂CF(CF₃)CH₂CF₂SO₂Cl are added dropwise to a mixture comprising 29 ml of freshly distilled cyclic sulfolane, 11.6 g (0.200 mole) of activated potassium fluoride, heated at 80° C. during 14 hours, under strong stirring. After filtration and treatment, the corresponding sulfonyl fluoride is distilled (T_{Eb}=57−60° C./21 mm Hg) with a yield of 85%. The compound, i.e. 5,6-dichloro-3-trifluoromethyl-1,1,3,4,4,5,6,6-octafluoro-hexane-1-sulfonyl fluoride, has tvo diastereoisomers.

RMN of ¹H (CDCl₃) δ: 3.2 (m, CH₂).

RMN of ¹⁹F (CDCl₃)δ: +48 (s, SO₂F, 1F); −68 (m, ClCF₂, 2F);

−71 (m, CF₃, 3F); −114 (t, ³J_{HF=16.3} Hz, CF₂SO₂Cl, 2F);

−116 to −121 (m, CFCl, 1F); −125 (m, CF₂ central, 2F); −182 (m, CF, 1F).

### Example 24

Synthesis of 3,5,6-Trichloro-1,1,3,4,4,5,6,6-Octafluorohexane-1-Sulfonyl Fluoride

Under the same conditions as previously, 15.6 g (0.036 mole) of CI CF₂CFClCF₂CFClCH₂CF₂SO₂Cl are slowly added in a three neckc flask containing 32 ml of freshly distilled cyclic sulfolane, 12.7 g (0.218 mole) of activated potassium fluoride, heated at 80° C. during 12 hours. After filtration and treatment, the corresponding sulfonyl fluoride is distilled (T_{Eb}=72−74° C./21 mm Hg) with a yield of 85%. The product, i.e. 3,5,6-trichloro-1,1,3,4,4,5,6,6-octafluorohexane-1-sulfonyl fluoride, has two diastereoisoiners.

RMN of ¹H (CDCl₃) δ: 3.4 (m, CH₂).

RMN of ¹⁹F (CDCl₃) δ: +48 (s, SO₂F, 1F); −68 (m, ClCF₂, 2F);

−110 (m, CFClCH₂, 1F); −114 (m, CF₂SO₂F, 2F);

−116 to −121 (m, ClCF₂CFCl, 1F); −120 (m, CF₂ central, 2F).

### Example 25

Synthesis of Trifluorovinyl Sulfonyl Fluoride

A balloon-flask with three tubular inlets provided with a distillation system (Vigreux columin, cooler and three receiver balloon placed in ice), a tapping funnel and a nitrogen inlet, contains 31.2 g (0.477 mole) of zinc activated with a mixture comprising 1.40 g of acetic acid and 1.40 g of acetic anhydride in 85 ml of anhydrous DMF. The mixture is heated at 110° C. in which are added dropwise, at that ternperature, 48.6 g (0.207 mole) of 1,2-dichlorotrifluoroethane-1-sulfohyl fluoride. Trifluorovinyl sulfonyl fluoride is distilled (Tg_{g-52}° C./760 mrn 1g) as it is forred. The yield is 63%.

RMN of ¹⁹F (CDCl₃) δ: +53 (s, SO₂F, 1F); −91 (dd, ²J_{FaFb} 49.8 Hz, 39.3 Hz, Fₐ,1F); −106.2 (dd, J_{FbFa}=49.7 Hz, J_{FbFc}=118.3 Hz, F_{b}, 1F); −165.3 (dd, ³J_{FcFa}=39.4 Hz, ³J_{FcFb}=118.5 Hz, F_{c}, 1F).

### Example 26

Synthesis of 1,1,3,4,4-Pentafluorobut-3-Ene-1-Sulfonyl Fluoride (M₁FSO₂F)

A three neck flask provided with a cooler and a nitrogen inlet contains a magnetic stirring bar, 11,07 g (0.169 mol) of zinc activated with a mixture comprising 1.0 of acetic acid and 1.0 g of acetic anhydride, and 50 ml of anhydrous DMF. After heating the mixture to 90° C., 22.0 g (0.074 mole) of 3,4-dichloro-1,1,3,4,4-pentafluorobutane-1-sulfonyl fluoride are added dropwise therein, under strong stirring. After total addition, the reaction mixture is allowed to be kept stirred, at 90° C. during 5 hours. After reaction and cooling, the excess zinc is filtrated and the reaction crude to which 50 ml of chloroform are added is washed with acid water (HCl 20%) neutralized tlhree times with NaHCO₃ and washed with water and finally dried on Na₂SO₄. After filtration and evaporation of chloroform, the 1,1,3,4,4-pentafluorobut-3-ene-1-sulfonyl fluoride is distilled (T_{Eb} 48−52° C./20 mm Hg). The yield is 66%.

RMN of ¹H (CDCl₃) δ: 2.95 (ddt, ³J_{HF}=15.3 Hz, ³J_{HF}=12.1 Hz, ⁴J_{HF}=3.5 Hz).

RMN of ¹⁹F (CDCl₃) δ: +45 (s, SO₂F, 1F); −102,4 (in, CF₂SO₂F, 2F),

−106.5 (ddt, ²J_{FaFb}=88.8 HZ, ³J_{FaFC}=33.3 Hz, ⁴J_{FaH}=2.3 Hz, Fₐ, 1F)

−125.8 (ddt, ²J_{FbFa}=88.8 Hz, J_{FbFc}=113.3 HZ, ⁴F_{bH}=3.7 Hz, F_{b}, 1F);

−175.2 (ddt, ³F_{cFb}=114.2 HZ, J_{FCFa}=33.1 HZ, ³J_{FcH}=22.3 Hz, F_{c}, 1F)

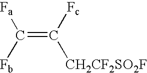

### Example 27

Synthesis of 1,1,1,2,3,3,4,5,5-Nonafluoropent-4-ene-2-Sulfonyl Fluoride(M₂FSO₂F)

Under the same experimental conditions as those of exaimple 26, 25.1 g (0.065 mole) of ClCF₂CFClCF₂CF(CF₃)SO₂F are added dropwise in 9.78 g (0.149 mole) of activated zinc strongly stirred in 50 ml of anhydrous DMF. After complete addition, reaction and treatment, the trifluorovinyl sulfonyl fluoride monomer is distilled (T_{Eb}=50−53° C./23 mm Hg). This compound, i.e. 1,1,1,2,3,3,4,5,5-nonafluoropent-4-ene-2-sulfonyl fluoride, is obtained with a yield of 58%.

RMN of ¹⁹F (CDCl₃) δ: +45 (s, SO₂F, 1F); −76.3 (in, CF₃, 3F);

−92.1 (ddt, ²J_{faFb}=49.2 Hz, ³J_{FaFc}=39.5 Hz, ⁴J_{FaF}=6.0 Hz, Fa, 1F);

−105.2 (ddt, ²J_{fbFa}, =49.5 HZ, ³J_{FbFc}=118.5 HZ, ⁴J _{FbF}=27.8 Hz, F_{b}, 1F)

−118.2 (m, CF₂, 2F); −189.7 (ddt, ³J_{FcFa}=39.8 Hz, J_{FcFb} =118.2 Hz, ³J_{FcF}=14.2 Hz, Fc, 1F); −205.1 (m, CF, 1F).

### Example 28

Synthesis of 1-Chloro-1,2,2,3,4,4-Hexafluorobut-3-ene-1-Sulfonyl Fluoride.

According to the same device as used in example 26, 16.1 g (0.046 mole) of ClCF₂CFClCF₂CFClSO₂F are added dropwise in 6.85 g (0.105 mole) of activated zinc in 40 ml of anhydrous DMF. After reaction and treatment, the chlorofluorinated monomer with sulfonyl fluoride end is distilled (T_{Eb}=62−68° C./22 imn Hg). This product, i.e. 1-chloro-1,2,2,3,4,4-hexafluorobut-3ene-1 sulfonyl fluoride, is obtained with a yield of 62%.

RMN of ¹⁹F (CDCl₃) δ: +45 (s, SO₂F, 1F);

−76 to −78 (part X of system ABX, CFCl);

−92.4 (ddt, ²J_{FaFb}=48.8 Hz, ³J_{FaFc}=38.6 Hz, ⁴J_{FaF}=5.9 HZ, Fₐ, 1P);

−115 to −120 (system AB complex, ⁴J_{FFa}=6.0 HZ, ³J_{FFb}=27.2 Hz);

−104.9 (ddt, J_{FbFa}=49.0 Hz, ³J_{FbFc}=118.2 Hz, ⁴J_{FbF}=27.4 Hz, F_{b}, 1F)

−188.7 (ddt, ³J_{FbFa}=38.7 Hz, ³J_{FcFb}=118.4 Hz, ³J_{FcF}=14.5 Hz).

### Example 29

Synthesis of 1,1,1,2,3,3,4,4,6,7,7-Undecafluorohept-6-ene-2-Sulfonyl Fluoride

In the same experimental conditions as those described for example 26, 15.1 g (0.033 mole) of ClCF₂CFClCH₂C₂F₄CF(CF₃)SO₂F are added dropwise in 5.02 g (0.077 mole) of strongly stirred activated zinc in 35 ml of anhydrous DMF. After reaction and treatment, the monomer containing a VDF unit and a HFP unit with sulfonyl fluoride end is distilled (T_{Eb}=49−53° C./21 mm Hg). This monomer, i,e. 1,1,12,3,3,4,4,6,7,7-undecafluorohept-6-ene-2-sulfonyl fluoride is obtained with a yield of 61%.

RMN of ¹H(CDCl₃) δ: 3.1 (m, CH₂).

RMN of ¹⁹F (CDCl₃) δ: +45 (s, SO₂F, 1F); −75.9 (m, CF₃, 3F);

−105.9 (ddt, ²J_{FaFb}=87.9 Hz, ³J_{FaFc}=33.0 Hz, ⁴J_{FaH}=2.2 Hz, Fₐ, 1F);

−110.2 (m, CH₂CF₂, 2F); −120.6 (m, CF₂CF, 2F);

−125.2 (ddt, J_{FbFa}=88.2 Hz, ³J_{FbFc}=113.9 Hz, ⁴J_{FbH}=3.5 Hz, F_{b}, 1F);

−175.7 (ddt, ³J_{FcFb}=114.2 Hz, ³J_{FcFa}=33.2 Hz, ³J_{FcH}=22.4 Hz, F_{c}, 1H);

−204.5 (m, CF, 1F).

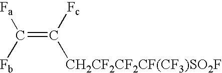

### Example 30

Synthesis of 4-chloro-1,1,1,2,3,3,4,5,5,6,7,7-dodeca-fluorohept-6-ene-2-sulfonyl fluoride

According to the same experimnental device as used in example 26, 10.0 g (0.020 mole of ClCF₂CFClCF₂CFClCF₂CF(CF₃)SO₂F are added dropwise in 3.00 g (0.046 mole) of activated zinc and 30 ml of anhydrous DMF. After reaction and treatment, the monomer with sulfonyl fluoride containing a CTFE unit and a HFP unit is distilled (T_{Eb}=66−68° C./20 mm Hg). This compound, i.e. 4-chloro-1,1,1,21,3,3,4,5,5,6,7,7dodecafluorohept-6-ene-2-sulfonyl fluoride is obtained with a yield of 59% and has two diastereoisomers.

RMN of ¹⁹F (CDCl₃) δ: +45 (S, SO₂F, 1F); −76.2 (m, CF_{3,} 3F)

−91.9 (ddt, ²J_{FaFb}=49.3 Hz, ³J_{FaFc}=39.3 Hz, ⁴J_{FaF} 5.9 HZ, F, 1F);

−105.2 (ddt, ²J_{FbFa}=49.5 Hz, 3J_{FbFc}=118.7 Hz, ⁴J^{FbF}=27.5 Hz, F_{b}, 1F)

−108 to −110 (complex system, ⁴J_{FbFa}=5.9 Hz, ⁴J_{FFb}=27.4 Hz,

³J_{FFC}=14.3 Hz, CF₂CFCl, 2F); −110 to −118 (m, CF₂CF, 2F);

−120 to −125 (m, CECI, 1F); −190.2 (ddt, ³J_{FcFa} 39.5 Hz,

³J_{FcFb}=118.5 Hz, ³J_{FcF}=14.2 Hz, F_{c}, 1F); −205.3 (m, CF, 1F).

### Example 31

Synthesis of 3-Trifluoromethyl-1,1,3,4,4,5,6,6-Octafluorohex-5-ene-1-Sulfonyl Fluoride

Under tlie same conditions as previously, 12.2 g (0.027 mole) of ClCF₂CFClCF₂CF(CF₃)CH2CF₂SO₂F are slowly added to 4.05 g (0.062 mole) of zinc activated with a mixture of acetic acid and acetic anhydride in 30 ml of anhydrous DMF. After filtration and treatment, the corresponding monomer with sulfonyl fluoride end is distilled (T_{Eb}=81−84° C./22 mm Hg). This product, i.e. 3-trifluoromethyl-1,1,3,4,4,5,6,6-octafluorohex-5-ene-1sulfonyl fluoride is obtained with a yield of 53%.

RMN of ¹H (CDCl₃) δ: 3.2 (m, CH₂).

RMN of ¹⁹F (CDCl₃) δ: +45 (s, SO₂F, 1F); −73.9 (m, CF₃, 3F);

−89.8 (ddt, ²J_{FaFb}=49.0 HZ, ³J_{FaFc}=39.2 Hz, ⁴J_{FbFc}=6.1 Hz, Fₐ, 1F);

−96.8 (m, CF₂SO₂F, 2F); −105.7 (ddt, ²J_{FbFa} 49.2 Iz, ³J_{FbFc}=18.4 Hz,

⁴J_{FbF}=27.3 Hz, F_{b}, 1F); −119.2 (m, CF₂, 2F); −182.2 (m, CF, 1F);

−189.9 (ddt, ³J_{FcFa}=39.4 Hz, ³J_{FCFb}=118.5 Hz, J_{FcF}=14.3 HZ, F_{c}, 1F).

### Example 32

Synthesis of 3-Chloro-1,1,3,4,4,5,6,6-Octafluorohex-5-ene-1-Sulfonyl Fluoride

Under the same experimental conditions as those described in example 36, 13.05 g (0.031 mole) of ClCF₂CFClCF₂CFClCH₂CF₂SO₂F are added dropwise in 4.75 g (0.072 mole) of activated zinc in 30 ml of anhydrous DMF. After addition, reaction and treatment, the monomer obtained is distilled (T_{Eb}=82−86° C./22 mm Hg). This compound, i.e. 3-chloro-1.1.3.4.4.5.6.6-octafluorohex-5−4n4−1-salfonyl fluoride is obtained with a yield of 63%.

RMN of ¹H (CDCl₃) δ: 3.4 (system AB, CH₂).

RMN of ¹⁹F (CDCl₃) δ: +45 (s, SO₂F, 1F);

−91.1 (ddt, ²J_{FaFb}=48.8 Hz, ³J^{FaFc}=39.3 Hz, ⁴J_{FaF}=6.0 Hz, Fₐ, 1F)

−96.2 (m, CH₂CF₂, 2F); −106.2 (ddt, ²J_{FbFa} 49.0 Hz, ³J_{FbFc}=118.2 Hz, ⁴J_{FbF}=27.2 Hz, F_{b}, 1F); −115 to −120 (m, CF₂CFCl, 2F);

−118 to −122 (m, CFCl, 1F); −190.2 (³J_{FcFa} 39.5 Hz, ³J_{FcFb}=118.4 Hz, ³J_{FCF}=14.2 Hz, F_{c}, 1F).

### Examples 33−36

Radical Copolymerizations VDF/F₂C═CFCH₂CF₂SO₂F (M₁FSO₂F) and VDF/HFP/CF₂═CFCH₂CF₂SO₂F (M₁FSO₂F)

In a 160 ml Hastelloy reactor, provided with twvo valves, a security disc and a manometer, there are introduced 12.8 g (0.056 mole) of CF₂═CFCH₁₂CF₂SO₂F (M₁FSO₂F), 0.61 g (0.0026 mol) of tertiobutyl peroxypivalate and 55.0 g of acetonitrile (example 34, table 1). The reactor is closed, placed under vacuum and cooled to −80° C., and 13.3 g (0.208 mole) of vinylidene fluoride (VDF) are introduced therein. The reactor is allowed to return to room temperature, and is then heated to 750 C in an oil bath during 15 hours. After cooling to room temperature and in ice, the reactor is degassed. Acetonitrile is partially evaporated, and the copolymer is precipitated by slow addition, dropwise, in 200 ml of strongly stirred cold pentane. The copolymer adheres to the walls of the Erlenmeyer and after decantation, separation and drying under vacuum at 80° C. until constant weight, 9.9 g of a highly viscous orange product are obtained. The yield is 38%. The chemical displacements of the fluorinated groups of the copolymers and terpolymers thus obtained (table 3) were determined without ambiguity from all the monomers and polymers obtained of which the experimental details and the results are given in table I and in the experimental part.

A differential calorimetric analysis (DSC), by means of a Perkin Elmer Pyris 1 apparatus standardized with indium and octadecane, from a sample of copolymer of about 15 mg, was realized by means of three heating cycles of −100° C. to +165° C. (at 40 then 20° C./min)/cooling from +165° C. to −100° C. (at 320° C./min). The results on the copolymers have shown a sinle glass transition temperature (T_{g}) corresponding to the inflexion point of the enthalpic jump. The second and third cycles have given reproducible T_{g} values. In the case of example 34, the T_{g} of the copolymer is −24.2° C. Thermogravimetric analyses (ATG) were carried out with a TGA 51−133 apparatur of Texas Instruments, under air, with a heatiig speed of 10° C./min. For example 34, a loss of 5% of the copolymer under air is noted starting at 294° C.

### Examples 37−39

Synthesis of Fluorosulfonated Elastomers by Radical Copolymerizations VDF/HFP/CF₂═CFCF₂CF(CF₃)SO₂F (M₂FSO₂F)

As in the case of examples 37−39 (table 1), we have used a 160 ml Hastelloy reactor (identical to the one used for examples 33−36) in which are introduced 8.2 g (0.026 mole) of CC=₂CFF₂CF(CF₃)SO₂F, 0.22 g (0.0015 mole) of tertiobutyl peroxide and 45.2 g of acetonitrite. The reactor is closed, placed under vacuum and cooled to −80° C., and there are successively introduced 13.4 g (0.089 mole) of hexafluoropropene (HFP) and 15.2 g (0.238 mole) of vinylidene fluoride (VDF). The reactor is allowed to return to room temperature, and is thereafter heated to 140° C. during a period of 18 hours during which the pressure goes through a maximum of 32 bars then decreases to 17 bars. After cooling in ice, the reactor is degassed and 14.5 g of VDF and HFP not having reacted were salted out (the conversion rate of the gaseous monomers is 49%). Characterization with RMN of ¹⁹F of the reaction crude has shown that 61% of the sulfonated monomer has reacted (the presence of the characterizing signal centered at −205 ppm establishes the presence of the monomer M₂FSO₂F not having totally reacted). Acetonitrile is partially evaporated and, as in the preceding example, the copolymer is precipitated by slow addition, dropwise, in 300 ml of strongly stirred cold pentane. After decantation, separation and drying under vacuum at 80° C. until constant weight, there is obtained 22.4 g of a highly viscous orange product. The yield by weight is 55%. The RMN spectrum of ¹⁹F permits to establish without ambiguity the molar percentages of the three comonoimers from the characterizing signals of the different fluorinated groups contained in the constitutive units of VDF (73.5%); of M₂FSO₂F (4.8%) and HFP (21.7%) (table 4). A calorimetric analysis (DSC) has shown the absence of peak caused by a fusion but the presence of an enthalpic jump caused by a single glass transition temperature (T_{g}=−20° C.). A thermogravimetric analysis (ATG) carried under air at 10° C. has shown that this copolymer lost about 5% of its weight at 301° C. The experimental details and the results of the other examples are summarized in table 2. A RMN analysis of the ¹⁹F characterizing the different chemical displacements of the various fluorinated groups is indicated in table 4.

Comments

This invention therefore describes for example the synthesis of new highly fluorinated monomers with sulfonyl fluoride end (MFSO₂F) containing VDF, and/or HFP, and/or CTFE, and their fluorinated elastomeric copolymers based on commercial fluorinated comonomers (such as VDF, HFP or CTFE) and possiblhy other fluorinated alkenes. The originality of this invention resides in the following facts:

1°) The preparation of original ttifluorovinyl monomers containing VDF, and/or HFP, and/or CTFE with sulfonyl fluoride end (WSO₂F), which are reactive in copolymnerization with commercial fluorinated alkenes or functional fluorinated monomers;

2°) the synthesis of fluorinated elastomers based on these perfluorovinyl monomers containing VDF, and/or HFP and with sulfonyl fluoride end (MFSO₂F), and possibly other fluorinated alkenes, is carried out with VDF and/or HFP instead of tetrafluoroethylene (TFE), the latter being largely used for the manufacture of fluorinated elastomers;

3°) the synthesis of fluorinated elastomers mentioned in this invention requires no use of monomers carriers of siloxanes groups, the latter generally contributing to a decrease of the glass transition temperature (TV;

4°) The cross-linkable fluorinated elastomers obtained by the present invention have aminor composition of trifluorovinyl monomers with sulfonyl fluoride (MFSO₂F) containing VDF, and/or hTP, and/or CTFE, having the structure F₂C═CFW(C₂H₂F₂)ₓ(C₂F₆)(C₂F₃Cl)_{z}SO₂F where W represents an oxygen atom or no atom; x being a natural whole number comprises between 0 and 10 inclusive; y=0 or 1 and z =0 or 1, and contains a major amount of VDF;

5°) The fluorosulfonated elastomers synthesized by said invention have very low glass transition temperatures (T_{g}), these elastomers thus finding applications in the field of plasturgy (<<aid processing>>or operating agents), or other high tech industries (aerospatial, electronic or automobile industries, petroleum, corrosive fluids, acids or very cold gases such as liquid nitrogen, oxygen and hydrogen transportation) and as materials for the energy sector (for example mebranes for fiel batteries fed for example with hydrogen or methanol). Moreover, highly resistant thermic seals may be prepared from these elastomners; and

6°) The fluorosulfonated elastomers are easily cross-linkable with hexarnetlyldisilazanes; this cross-linking significantly improves the properties of resistance to oxidation and to solvents, to hydrocarbons, to fuiels, acids, bases and aggressive media.

Among the advantages associated with the present invention, the following may be mentioned:

1°) the preparation of original trifluorivinyl monomers with sulfonyl fluoride end containing VDF or HFP by simple synthetic means (from radical mono-addition of commercial transfer agents or by synthesis on CTFE, VDF or BEP or by (co)telomerization of these fluorinated allenes); these fluorosulfonated monomers contain no ether bridge;

2°) said fluorosulfonated monomers are reactive in copolymerization;

3°) the copolymerization process is carried out in batch (<<batch>> type);

4°) the process that is mentioned in this invention is carried out in solution and uses known organic solvents, that are easily available on the market;

5°) the process of said invention consists in a radical polymerization in the presence of known initiators, that are easily available on the market;

6°) tetrafluoroethylene (TFE) is not used in this invention;

7°) the fluorinated olefin that is in the composition of the fluorinated elastomers prepared by said invention is vinylidene fluoride (VDF); the latter is clearly less costly and much less dangerous to handle than TFE and gives to the clastomers obtained a good resistance against oxidation, against chemical agents, against polar solvents and against petroleum and a noted decrease of the glass transition temperature (T_{g});

8°) the fluorinated elastomers that are mentioned in said invention are prepared from the original monomers mentioned above in point 1°) and their copolymerization with VDF and their terpolymerization with VDF and HFP were never mentioned in the works described in the art. Moreover, these sulfonated monomers through their sulfonyl fluoride function, permit to provide cross-linking sites (for example of the sulfonamide type) in these elastomers,

9°) the fluorinated elastomers obtained by this process have very low lass transition temperatures, the latter being preferably lower than −20° C.; and

10°) these fluorosulfonated copolymers may be easily cross-linked by means of hexamethyldisilazane, thus giving materials that are stable, inert and insoluble in all solvents, hydrocarbons or strong acids.

Although the present invention has been described by means of specific embodiments, it is understood that many variations and modifications may be associated with such modifications, uses or adaptations of the present invention following in general, the principles of the invention and including any variation of the present description that will become known or conventional in the field of activity in which the present invention is involved, and that my apply to the essential elements mentioned above, in accordance with the scope of the following claims.

1. Fluorofunctional random copolymers corresponding to formula V₁: 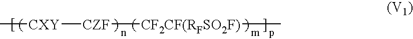
in which: X, Y and Z represent a hydrogen or fluorine atom or a CF₃ group;
n, m and p independently represent natural whole numbers that are between 1 and 20 for n, between 1 and 10 for m and between 5 and 400 for p; and
R_{F} represents one or more units selected from the group comprising vinylidene, hexafluoropropene and chlorotrifluoroethylene fluoride units.

2. Fluorofunctional random copolymers according to claim 1 corresponding to formula VI: 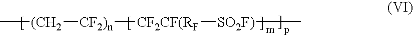
and in which: R_{F} represents one or more units selected from the group comprising vinylidene fluoride, hyxafluoropropene and chlorotrifluoroethylene fluoride units.

3. Fluorofunctional copolymers according to claim 1 or 2, in which n is between 3 and 10, m is between 1 and 5, and p is between 10 and 300.

4. Canceled.

5. Canceled.

6. Fluorosulfonated copolymers according claim 3, containing 68 to 96 mole % of vinylidene fluoride.

7. Fluorosulfonated copolymers according to claim 3, containing 4 to 32 mole % of highly fluorinated trifluorovinyl monomer with sulfonyl fluoride end.

8. Fluorosulfonated copolymers according to claim 7, in which the highly fluorinated trifluorovinyl monomer units with sulfonyl fluoride end are derived from the monomer 1,1,3,4,4-pentafluorobut-3-ene-1-sulfonyl fluoride or 1,1,1,2,3,3.4.5.5-nonafluoropent-4-ene-2-sulfonyl fluoride.

9. Canceled.

10. Process for preparing the copolymers of claim 1 or 2 comprising the reaction of a compound of formula I:
F₂C═CF—R_{F}—SO₂F (I)
in which: R_{F} represents one or more units selected from the group consisting of vinylidene fluoride, hexafluoropropene and chlorotrifluoroethylene fluoride units;
with a compound corresponding to formula V:
XYC═CZF (V)

11. Process for preparing copolymers according to claim 10, in which the compound I corresponds to formula 11:
F₂C═CF(CH₂CF₂)_{w}[CF₂CF(CF₃)]ₓCF₂CFCl)_{y}SO₂F (II)
in which: w, x and z are natural whole numbers that independently vary between 0 and 10 for w, between 0 and 5 for x and between 0 and 5 for y.

12. Process for preparing the copolymers of claim 2, comprising the reaction of a compound corresponding to formula V′:
F₂C═CH₂ (V′)
with a compound corresponding to formula I as defined in claim 10 or 11.

13. Fluorofunctional random copolymers corresponding to formula VIII: 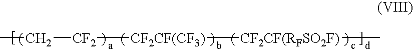
in which: a, b, c and d independently represent natural whole numbers, such that the ratio a/b varies from 1 to 15, the ratio a/c varies from 1 to 25 and d varies from 10 to 400;
and in which: R_{F} represents one or more units selected from the group consisting of vinylidene fluoride, hexafluoropropene and chlorotrifluoroethylene fluoride units.

14. Fluorofunctional copolymers according to claim 13, in which the ratio a/b varies from 2 to 10, the ratio a/c varies from 2 to 15, and d varies from 25 to 250.

15. Canceled.

16. Canceled.

17. Fluorosulfonated copolymers according to claim 14 containing 54 to 76 mole % of vinylidene fluoride.

18. Fluorosulfonated copolymers according to claim 14 containing 11 to 34 mole % of hexafluoropropene.

19. Fluorosulfonated copolymers according to claim 14 containing 2 to 12 mole % of highly fluorinated trifluorovinyl monomer with sulfonyl fluoride end.

20. Fluorosulfonated copolymers according to claim 19 in which the highly fluorinated trifluorovinyl monomer units with sulfonyl fluoride end are derived from the monomer 1,1,3,4,4-pentafluorobut-3-ene-1-sulfonyl fluoride, or 1,1,1,2.3.3.4.5.5-nonafluoropent-4-ene-2-sulfonyl fluoride.

21. Canceled.

22. Canceled.

23. Canceled.

24. Canceled.

25. Canceled.

26. Fluorosulfonated copolymers according to claim 1, 2 or 13 having a glass transition temperature, measured according to ASTM norm E-1356−98, that is lower than 0° C.

27. Canceled.

28. Fluorosulfonated copolymers according to claim 26 having a glass transition temperature lower than −20° C.

29. Canceled.

30. Fluorosulfonated copolymers according to claims 1,2 or 13 characterized in that they have a thermo-stability, measured by thermogravimetric analysis (<<TGA>>), up to 315° C. under air at 10° C. per minute, temperature value at which a loss of weight of 5% is measured.

31. Process for preparing, fluorofunctional random copolymers comprising the reaction:
of a compound corresponding to formula V′:
F₂C═CH₂ (V′)
with a compound of formula I:
F₂C═CF—R_{F}—SO₂F (I)
in which: R_{F} represents on or more units selected from the group consisting of vinylidene fluoride, hexafluoropropene and chlorotrifluoroethylene fluoride units; and
with a compound corresponding to formula VII:
F₂C═CFCF₃ (VII)

32. Canceled.

33. Canceled.

34. Process of copolymenzation according to claim 31, initiated in the presence of at least one organic radical initiator ou in the presence of at least one persulfate.

35. Process of copolymerization according to claim 34, characterized in that the radical initiator is at least one peroxide and/or at least one perester.

36. Process according to claim 31, characterized in that it is carried out in the presence of t-butyl peroxypivalate at a temperature pfefefably between 70 and 80° C., or in the presence of t-butyl peroxide at a temperature between 135 and 145° C.

37. Process according to claim 10 or 31, for the preparation of fluorofunctional copolymers in the presence of at least one organic solvent preforably selected from the group consisting of:
esters of formula R-COO—R′ where R and R′ are independently selected from hydrogen, alkyl groups that contain 1 to 5 carbon atoms, hydroxy (OH) groups and ether groups OR″ where R″ is an alkyl containing 1 to 5 carbon atoms; and
fluorinated solvents of the type: perfluoro-n-hexane, n—C₄F₁₀, perfluoro-2-butyltetrahydrofurane (FC 75); and
acetone, 1,2-dichloroethane, isopropanol, tertiobutanol, acetonitrile or butyronitrile; and
corresponding mixtures.

38. Process according to claim 37, characterized in that the organic solvent is perfluoro-n-hexane or acetonitrile.

39. Process of copolymerization according to claim 10 or 31, characterized in that the initial molar ratios [initiator]₀Σ[monomers]ₒ are between 0.1 and 2%, preferably between 0.5 and 1%, the expression [initiator]ₒ meaning the initial molar concentration of initiator and the expression Σ[monomers]₀ meaning the total initial monomer concentration.

40. Monomers corresponding to formula I:
F₂C═CF—R_{F}—SO₂F (I)
in which: R_{F} represents one or more units selected from the group consisting of vinylidene fluoride, hexafluoropropene and chlorotrifluoroethylene units.

41. Monomers according to claim 40 corresponding to formula II:
F₂C═CF(CH₂CF₂)_{w}[CF₂CF(CF₃)]ₓ(CF₂CFCl)_{y}SO₂F (II)
in which: w, x and y are natural whole numbers that independently vary between 0 and 10 for w, between 0 and 5 for x and between 0 and 5 for y,
excluding the monomer corresponding to the case wherein w, x and y are simultaneously 0.

42. Monomers according to claim 41, in which the vinylidene fluoride, hexafluoropropene and chlorotrifluoroethylene units are randomly dispersed, i.e. they are not in the form of blocks.

43. Monomers according to claim 40 or 41, in which w is a natural whole number comprised between 0 and 5 inclusive, x represents 0 or 1 and y represents 0 or 1.

44. Canceled.

45. Canceled.

46. Monomer according to claim 40 or 41, corresponding to formula II₁:
F₂C═CFCH₂CF₂SO₂F (II₁)

47. Canceled.

48. Process for the preparation of monomers according to claim 40 or 41 by chemical transformation of telomers of formula III:
ClCF₂CFCl(CH₂CF₂)_{w}[CF₂CF(CF₃)]ₓ(CF₂CFCl)_{y}I (III)
in which: w, x and y are natural whole numbers that independently vary between 0 and 10 for x and between 0 and 5 for y, said chemical transformation being a process including at least the following two or three steps: sulfination, chlorination and fluorination of the end group —SO₂Na;
into compounds of formula IV:
ClCF₂CFCl-R_{F}—SO₂F (IV)
in which: R_{F} represents the group (CH₂CF₂)_{w}[CF₂CF(CF₃)]₂—(CF₂CFCl)_{y} and where w, x and y are natural whole numbers that independently vary between 0 and 10 for w, between 0 and 5 for x and between 0 and 5 for y;
and by dechlorination of the fluorosulfonated telomers of formula IV thus obtained into compound of formula II:
F₂C═CF(CH₂CF₂)_{w}[CF₂CF(CF₃)]ₓ(CF₂CFCl)_{y}SO₂F (II)
in which: w, x and y are natural whole numbers that independently vary between 0 and 10 for w, between 0 and 5 for x and between 0 and 5 for y.

49. Canceled.

50. Telomers corresponding to formula III:
ClCF₂CFCl(CH₂CF₂)_{w}[CF₂CF(CF₃)]ₓ(CF₂CFCl)_{y}I (III)
in which: w, x and y are natural whole numbers that independently vary between 0 and 10 for w, between 0 and 5 for x and between 0 and 5 for y, provided
the telomers corresponding to the case wherein w and x represent 0 and y represents 1;
the telomers corresponding to x and y being 0 and w ranging from 1 to 4; and
the telomers corresponding to x and y being 0 and x ranging from 1 to 5 being excluded.

51. Telomers according to claim 50 in which w represents a natural whole number compdess between 0 and 5, in which x represents 0 or 1, in which y represents 0 or 1.

52. Canceled.

53. Canceled.

54. Canceled.

55. Canceled.

56. Canceled.

57. Canceled.

58. Canceled.

59. Canceled.

60. Canceled.
